(19) United States
(12) Patent Application Publication
(10) Pub. No.: US 2025/0076444 A1
(43) Pub. Date: Mar. 6, 2025

(54) DYNAMIC MEASUREMENT AND REPORTING FOR POSITIONING

(71) Applicant: QUALCOMM Incorporated, San Diego, CA (US)

(72) Inventors: Mohammed Ali Mohammed HIRZALLAH, San Diego, CA (US); Srinivas Yerramalli, San Diego, CA (US); Taesang Yoo, San Diego, CA (US)

(21) Appl. No.: 18/457,966

(22) Filed: Aug. 29, 2023

(51) Int. Cl. G01S 5/00; H04L 5/00; H04W 24/10

(52) U.S. Cl. CPC G01S 5/0036; H04L 5/0048; H04W 24/10

(57) ABSTRACT

A user equipment (UE) may receive a configuration message including a plurality of configurations to at least one of measure or report a set of positioning signals. The UE may select a configuration from the plurality of configurations. The UE may receive the set of positioning signals. The UE may measure the set of positioning signals and transmit a first report message including a first report of the measured set of positioning signals based on the selected configuration. The UE may measure the set of positioning signals based on the selected configuration and transmit a second report message including a second report of the measured set of positioning signals. The UE may measure the set of positioning signals based on the selected configuration and transmit a third report message including a third report of the measured set of positioning signals based on the selected configuration.

### TECHNICAL FIELD

The present disclosure relates generally to communication systems, and more particularly, to a positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive a configuration message including a plurality of configurations to at least one of measure or report a set of positioning signals. The apparatus may select a configuration from the plurality of configurations. The apparatus may receive the set of positioning signals. The apparatus may measure the set of positioning signals and transmit a first report message including a first report of the measured set of positioning signals based on the selected configuration. The apparatus may measure the set of positioning signals based on the selected configuration and transmit a second report message including a second report of the measured set of positioning signals. The apparatus may measure the set of positioning signals based on the selected configuration and transmit a third report message including a third report of the measured set of positioning signals based on the selected configuration.

In an aspect of the disclosure, a method, a computer-readable medium, and an apparatus are provided. The apparatus may include a base station, a transmission reception point (TRP), or a location management function (LMF). The apparatus may transmit a first configuration message including a plurality of configurations to at least one of measure or report a set of positioning signals. The apparatus may transmit a second configuration message including a positioning configuration to transmit the set of positioning signals. The apparatus may receive a report message including a report of a measured set of positioning signals that are at least one of measured or reported based on a configuration of the plurality of configurations.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5 is a diagram illustrating an example of positioning based on positioning signal measurements.

FIG. 6 is a communications flow diagram illustrating an example of positioning based on dynamic positioning signal measurements and/or reporting.

FIG. 7 is a communications flow diagram illustrating an example of positioning based on dynamic positioning signal measurements and/or reporting.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless positioning systems. Some aspects more specifically relate to dynamic configuration for wireless positioning systems. In some examples, a user equipment (UE) may receive a configuration message including a plurality of configurations to at least one of measure or report a set of positioning signals. The UE may use each of the plurality of configurations to at least one of measure, or report a measurement of, the set of positioning signals. The UE may dynamically select a configuration from the plurality of applicable configurations.

The UE may receive the set of positioning signals. The UE may measure the set of positioning signals and transmit a first report message including a first report of the measured set of positioning signals based on the selected configuration. The UE may measure the set of positioning signals based on the selected configuration and transmit a second report message including a second report of the measured set of positioning signals. The UE may measure the set of positioning signals based on the selected configuration and transmit a third report message including a third report of the measured set of positioning signals based on the selected configuration.

In some examples, a network node, such as a base station, a transmission reception point (TRP), a core network, or a location management function (LMF), may transmit a first configuration message including a plurality of configurations to at least one of measure or report a set of positioning signals. The network node may transmit a second configuration message including a positioning configuration to transmit the set of positioning signals. The network node may receive a report message including a report of a measured set of positioning signals that are at least one of measured or reported based on a configuration of the plurality of configurations.

In some aspects, a UE may measure positioning signals and transmit a measurement report to a network node, for example a base station, a TRP, or an LMF. In UE-assisted positioning, measurements reported by UE may include basic measurements or enhanced measurements. While reporting enhanced measurements may increase accuracy, reporting enhanced measurements may also increase reporting overhead. In some aspects, techniques to balance accuracy and reporting overhead using dynamic reporting may be used to adapt the reporting overhead based on one or more factors, for example a conditional accuracy of an operating scenario (e.g., line-of-sight (LOS), mild non-line-of-sight (NLOS), NLOS). In some aspects, an LMF may configure a UE for dynamic reporting using one or more reporting classes. Each reporting class may correspond with at least one of (a) a subsampling measurement criteria, (b) subsampling resource criteria (e.g., TRP selection criterion), (c) a measurement attribute, (d) a measurement format, (e) a measurement resolution, etc. A set of TRPs may transmit a set of positioning signals. The UE may receive at least some of the set of positioning signals, measure the at least some of the set of positioning signals, subsample the positioning signals according to a configuration, and/or report the subsampled measurements according to the configuration. The UE may transmit the report to a network node, such as an LMF. The network node may use the reported subsampled measurements to calculate the position of the UE. A subsample may be a subset of sampled measurements.

Particular aspects of the subject matter described in this disclosure can be implemented to realize one or more of the following potential advantages. In some examples, by allowing a UE to dynamically adjust how it measures and/or reports positioning signals, the described techniques can be used to perform a dynamic tradeoff between positioning accuracy and measurement reporting overhead. In some simple scenarios (e.g., LOS, mild NLOS), the UE may use simplified measurement reporting with small/mild reporting overhead to enable a satisfactory positioning accuracy for UE-assisted positioning. In more sophisticated scenarios (e.g., strong NLOS), the UE may use detailed measurement reporting with high reporting overhead to enable satisfactory positioning accuracy for UE-assisted positioning. In some aspects, long-term evolution (LTE) positioning protocol (LPP) configurations and reporting may be configured to adapt the reporting quantities/type for balancing between a conditional accuracy and resultant reporting overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

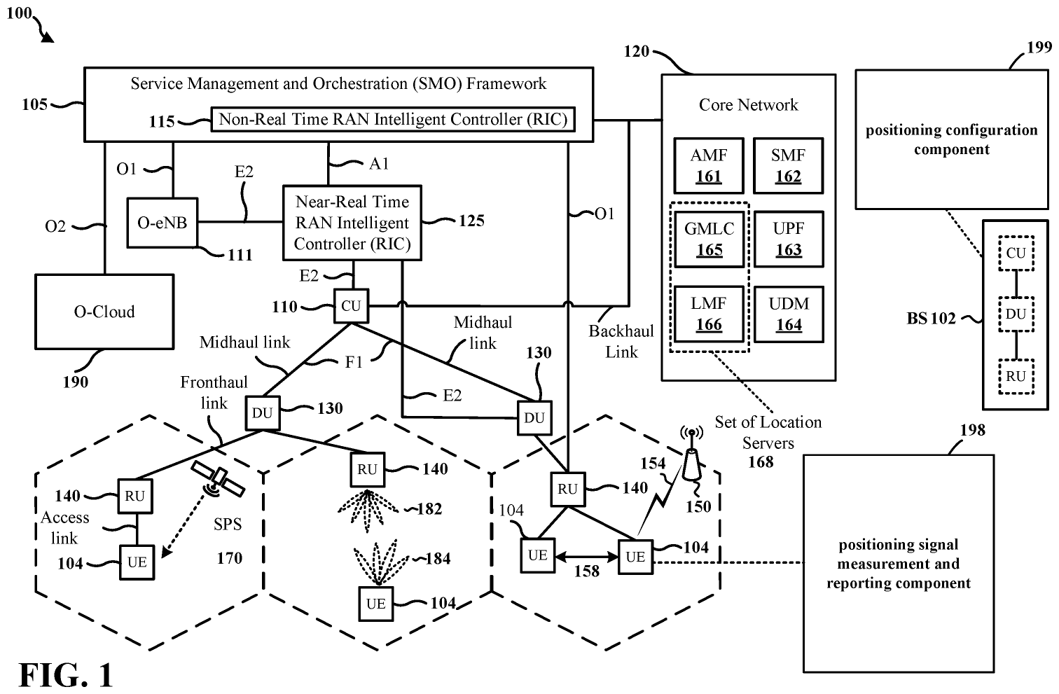

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a positioning signal measurement and reporting component 198 that may be configured to receive a configuration message including a plurality of configurations to at least one of measure or report a set of positioning signals. The positioning signal measurement and reporting component 198 may be configured to select a configuration from the plurality of configurations. The positioning signal measurement and reporting component 198 may be configured to receive the set of positioning signals. The positioning signal measurement and reporting component 198 may be configured to measure the set of positioning signals and transmit a first report message including a first report of the measured set of positioning signals based on the selected configuration. The positioning signal measurement and reporting component 198 may be configured to measure the set of positioning signals based on the selected configuration and transmit a second report message including a second report of the measured set of positioning signals. The positioning signal measurement and reporting component 198 may be configured to measure the set of positioning signals based on the selected configuration and transmit a third report message including a third report of the measured set of positioning signals based on the selected configuration. In certain aspects, the base station 102, core network 120, one or more location servers 168, and/or LMF 166 may have a positioning configuration component 199 that may be configured to transmit a first configuration message including a plurality of configurations to at least one of measure or report a set of positioning signals. The positioning configuration component 199 may be configured to transmit a second configuration message including a positioning configuration to transmit the set of positioning signals. The positioning configuration component 199 may be configured to receive a report message including a report of a measured set of positioning signals that are at least one of measured or reported based on a configuration of the plurality of configurations.

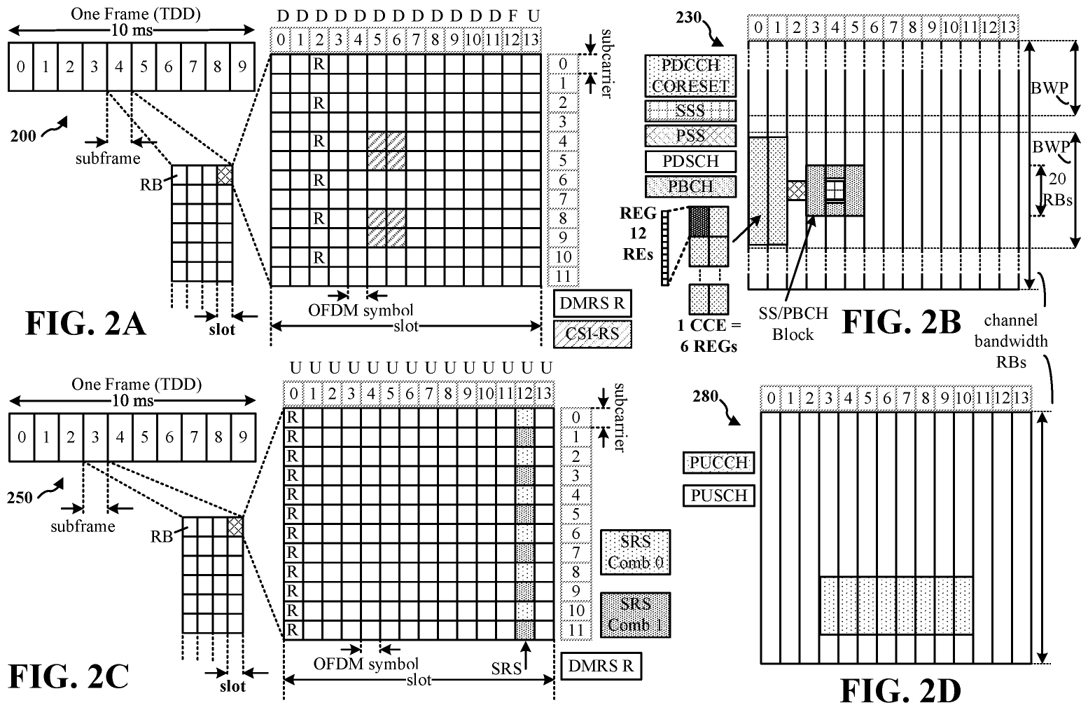

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

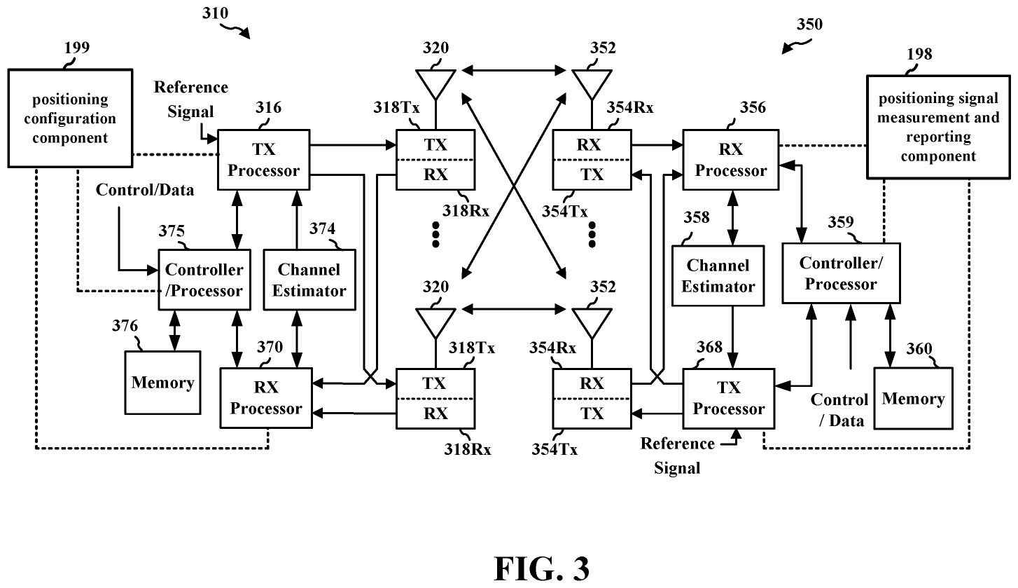

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning signal measurement and reporting component 198 of FIG. 1.

At least one of the TX processor 316, the RX processor 370, and the controller/processor 375 may be configured to perform aspects in connection with the positioning configuration component 199 of FIG. 1.

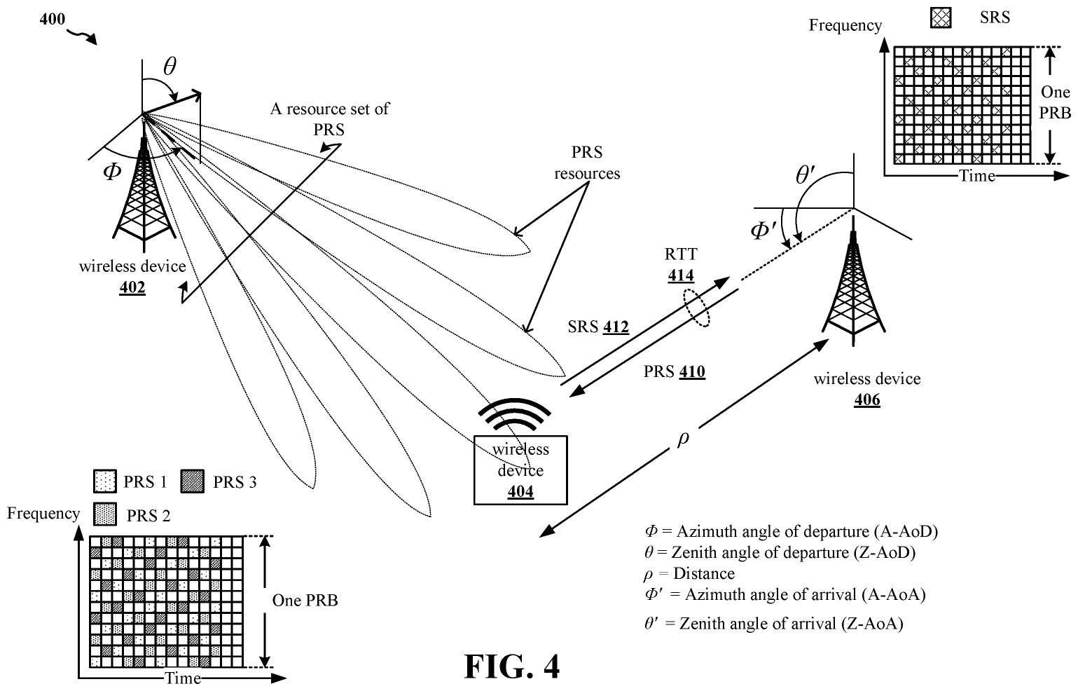

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time T_{SRS_TX} and receive DL positioning reference signals (PRS) (DL-PRS) 410 at time T_{PRS_RX}. The wireless device 406 may receive the UL-SRS 412 at time T_{SRS_RX} and transmit the DL-PRS 410 at time T_{PRS_TX}. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}−T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase e accuracy, to determine and/or to enhance certainty, to supplement/complement measurements, and/or to substitute/provide for missing information.

In some aspects, a wireless device may be configured to calculate a position of a wireless device. A position of a wireless device may include both the location of the wireless device and the orientation of the wireless device, for example an orientation of an antenna with a stronger signal in one direction relative to the location of the wireless device than another direction relative to the location of the wireless device. The strength of a signal received by a wireless device may be used to calculate an orientation of the wireless device, particularly if a plurality of paths to/from the wireless device are calculated, for example via a plurality of wireless devices transmitting/receiving positioning signals, or via a plurality of paths between wireless devices (e.g., the strength of a signal transmitted via a direct LOS path and the signal transmitted via an indirect, NLOS path). A system configured to calculate a position of a wireless device may be configured to calculate the location of the wireless device, and vice-versa.

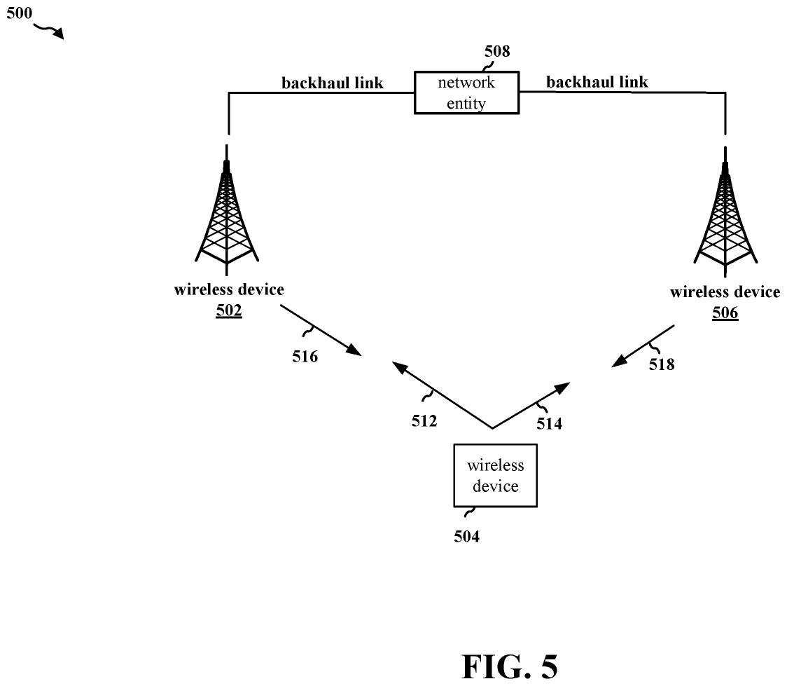

FIG. 5 is a diagram 500 illustrating a network entity 508 that may be configured to coordinate a wireless device 502 and a wireless device 506 to perform positioning with a wireless device 504. The location of the wireless device 502 and the wireless device 506 may be known to at least one device, such as the wireless device 502, the wireless device 504, the wireless device 506, and/or the network entity 508. The wireless device 502 may be a base station, a gNB, or a TRP. The wireless device 506 may be a base station, a gNB, or a TRP. The wireless device 504 may be a UE or a PRU. A PRU may be a UE with a known location, for example the PRU may be affixed in place or may be placed in a known location for a period of time, or the PRU may have a set of sensors (e.g., high-accuracy GNSS sensor) that may be used to accurately calculate the location of the PRU. The network entity 508 may be connected to the wireless device 502 and the wireless device 506 via a physical link, for example a backhaul link or a midhaul link, or via a wireless link, such as an air interface (Uu) link. The network entity 508 may be part of a core network, such as an LMF or a set of location servers. The network entity 508 may configure positioning occasions between the wireless device 502, the wireless device 504, and the wireless device 506.

To perform positioning, the network entity 508 may configure one or more of the wireless devices to transmit positioning signals at one another. For example, the wireless device 504 may transmit the set of positioning signals 512 at the wireless device 502. The set of positioning signals 512 may be a set of SRSs, SSBs, or CSI-RSs. The wireless device 502 may measure the set of positioning signals 512. The wireless device 502 may transmit the set of positioning signals 516 at the wireless device 504. The set of positioning signals 516 may be a set of PRSs, SSBs, or CSI-RSs. The wireless device 504 may measure the set of positioning signals 516. The wireless device 504 may transmit a set of positioning signals 514 at the wireless device 506. The set of positioning signals 514 may be a set of SRSs, SSBs, or CSI-RSs. The wireless device 506 may measure the set of positioning signals 514. The wireless device 506 may transmit a set of positioning signals 518 at the wireless device 504. The set of positioning signals 518 may be a set of PRSs, SSBs, or CSI-RSs. The wireless device 504 may measure the set of positioning signals 518. One or more of the wireless devices may measure the received positioning signals to calculate a positioning measurement that may be used to calculate a position/location of the wireless device 504, or may be used to calculate a position/location of the wireless device 504. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known. Other measurements, such as RTOA, line-of-sight (LOS) identification (identifying whether there is a direct line-of-sight path between wireless devices), or multi-cell round trip time (multi-RTT) calculations may be performed to calculate the position of the wireless device 504, or to calculate a measurement that may be used to calculate the position of the wireless device 504.

In some aspects, a positioning model may be used to calculate one or more positioning metrics based on the measurements. For example, based on the measurements of the set of positioning signals 512 and/or the set of positioning signals 514 transmitted by the wireless device 504, a position/location of the wireless device 504 may be calculated or estimated, or an intermediate measurement that may be used to calculate the position/location of the wireless device 504 may be calculated or estimated. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, or a CSI-RS. An RS transmitted from a UE, such as a PRU, may be referred to as an uplink positioning signal, or an UL positioning signal. An RS transmitted from a base station, or TRP, may be referred to as a downlink positioning signal, or a DL positioning signal. A measurement may be a channel impulse response (CIR), a channel frequency response (CFR), power delay profile (PDP), a delay profile (DP), a multipath measurement type (e.g., multi-RTT, reference signal received power path (RSRPP), TDOA) or another measurement used for performing positioning on a target wireless device. A label may be a calculated, derived, or given (i.e., known) expected result associated with a set of inputs, such as a position/location of a wireless device 504 or an intermediate measurement (e.g., a timing measurement, an angle measurement, a LOS identification) that may be used to calculate the position/location of the wireless device 504. A set of inputs and a set of labels may be used for generating and/or training a positioning model using AI/ML.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 502 may have a positioning model configured to accept a set of positioning measurements and generate an estimate of a position/location of the wireless device 504. In another example, the wireless device 502 may have a positioning model configured to accept a set of positioning measurements and generate an intermediate measurement (e.g., a timing measurement, an angle measurement, a LOS identification) that may be used (by the wireless device 502, or another entity, such as the network entity 508, the wireless device 504, or the wireless device 506) to calculate the position/location of the wireless device 504. In another example, the network entity 508 may have a positioning model configured to accept a set of positioning measurements and generate an estimate of a position/location of the wireless device 504, or generate an intermediate measurement that may be used to calculate the position/location of the wireless device 504. In another example, the wireless device 504 may have a positioning model configured to accept a set of positioning measurements and generate an estimate of a position/location of the wireless device 504, or generate an intermediate measurement that may be used to calculate the position/location of the wireless device 504. In some aspects, the positioning measurements may be aggregated by the entity with the positioning model, for example the network entity 508 may aggregate measurements of the set of positioning signals 512 from the wireless device 502, measurements of the set of positioning signals 514 the wireless device 506 to use as inputs to a positioning model, measurements of the set of positioning signals 516 from the wireless device 504, and/or measurements of the set of positioning signals 518 from the wireless device 504.

A positioning model may be trained on a wireless device that performs positioning, such as the wireless device 502, the wireless device 504, the wireless device 506 and/or the network entity 508, or may be trained on an offline device, such as an over-the-top (OTT) server. The inputs to the positioning model may include measurements of positioning signals, such as measurements of SRS, PRS, SSB, and/or CSI-RS. The inputs to the measurements may include assistance information associated with the measured positioning signals, such as BWP of a positioning signal resource, number of TRPs, beam information, positioning signal configuration). The labels/outputs for the positioning model may include a location, or an intermediate measurement.

In some aspects, a positioning model may be configured to use measurements of positioning signals transmitted from a wireless device to calculate a position of the wireless device 504, or to calculate an intermediate measurement that may be used to calculate the position of the wireless device 504. The positioning model may be trained via a training entity, and may be used at the wireless device 502, at the wireless device 504, at the wireless device 506, or at the network entity 508. For example, a positioning model at the wireless device 504 may be configured to calculate the location of the wireless device 504 based on measurements of the set of positioning signals 516 and/or the set of positioning signals 518. In another example, the wireless device 502 may transmit a set of intermediate measurements to the network entity 508 so that the network entity 508 may calculate the location of the wireless device 504 based on the set of intermediate measurements. In another example, the wireless device 504 may transmit measurements of the set of positioning signals 516 and/or the set of positioning signals 518 to the network entity 508. The positioning model may be at the network entity 508. The positioning model at the network entity 508 may calculate the location of the wireless device 504 based on the transmitted measurements of the set of positioning signals 516 and/or the set of positioning signals 518 from the wireless device 504, the transmitted measurements of the set of positioning signals 512 from the wireless device 502, and/or the transmitted measurements of the set of positioning signals 514 from the wireless device 506. In other words, any of the wireless device 502, the wireless device 504, and/or the wireless device 506 may assist the network entity 508 in performing positioning using a trained positioning model.

Measurements of positioning signals may be performed by measuring channels between a target device (e.g., the wireless device 504) and a set of network nodes (e.g., the wireless device 502 and the wireless device 506). The wireless device 504 may transmit a positioning signal, such as an SRS, an SSB, or a CSI-RS. The wireless device 502 and/or the wireless device 506 may measure the positioning signal for data collection purposes to train a positioning model. The wireless device 504 and/or the wireless device 506 may transmit a positioning signal, such as a PRS, an SSB, or a CSI-RS. The wireless device 504 may measure the positioning signal for data collection purposes to train the positioning model. The wireless device 502, the wireless device 504, and/or the wireless device 506 may measure a positioning signal resource in a plurality of ways, for example the measurement may be a channel impulse response (CIR), a channel frequency response (CFR), a power delay profile (PDP), a delay profile (DP), a multipath measurement type, a set of reflection paths, a reception-transmission (Rx-Tx) time difference, a received signal strength indicator (RSSI), a reference signal received power (RSRP), a reference signal received power path (RSRPP), a reference signal received quality (RSRQ), a time of arrival (ToA), a reference signal time difference (RSTD), or an angle of departure (AoD).

While diagram 500 illustrates two positioning neighbor wireless devices, wireless device 502 and wireless device 506, configured to perform positioning with one positioning target wireless device, wireless device 504, to calculate a position/location of the wireless device 504, any number of positioning neighbor wireless devices may be configured to perform positioning with any number of positioning target wireless devices. For example, four positioning neighbor wireless devices may be configured to calculate the position/location of two positioning target wireless devices, three positioning neighbor wireless devices may be configured to calculate the position/location of one positioning target wireless device, or two positioning neighbor wireless devices may be configured to calculate the position/location of one positioning target wireless device.

In some aspects, a wireless device may be configured to measure/report positioning measurements dynamically, where the reporting overhead may be dynamically changed based on an operation scenario/condition. In some aspects, the network entity 508 may configure one or more of the wireless device 502, the wireless device 504, and/or the wireless device 506 with a plurality of measurement/reporting classes, which a wireless device may select from in order to enable dynamic reporting. Each measurement/reporting class may represent a measurement type, a measurement format, a set of measurement attributes, subsampling measurement information/criterion, and/or subsampling resource information/criterion. The set of measurement attributes may include, for example, timing information, frequency information, and/or magnitude. In contrast, measurement types may include, for example, CIR, CFR, PDP. DP, or multipath measurement types. The measurement/reporting configuration may be configured as a part of LPP procedures.

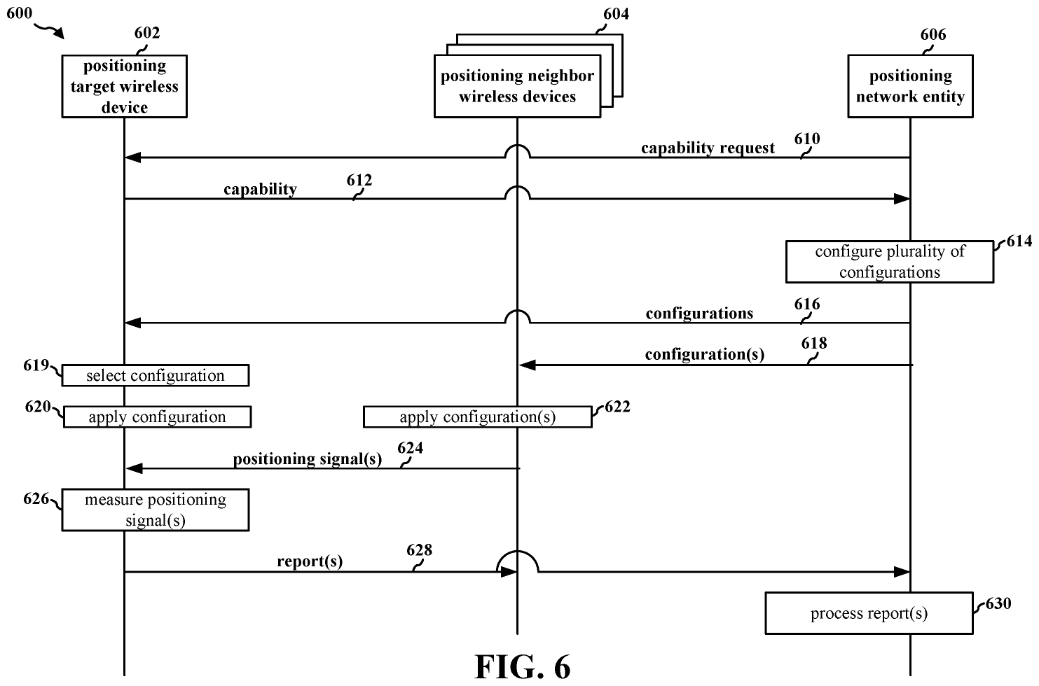

FIG. 6 is a connection flow diagram 600 illustrating an example of communications between a positioning target wireless device 602, a set of positioning neighbor wireless devices 604, and a positioning network entity 606. The positioning target wireless device 602 may be a UE. The set of positioning neighbor wireless devices 604 may include a set of base stations and/or a set of TRPs configured to transmit positioning signals at the positioning target wireless device 602. The positioning network entity 606 may include an LMF, or may include one or more location servers. The positioning network entity 606 may be configured to configure positioning occasions between the positioning target wireless device 602 and the set of positioning neighbor wireless devices 604. The positioning network entity 606 may be configured to configure a set of measurement/reporting classes that allow the positioning target wireless device 602 to perform dynamic reporting of measurements of the set of positioning signals 624 transmitted by the set of positioning neighbor wireless devices 604. A measurement reporting class may also be referred to as a configuration. In other words, the positioning network entity 606 may configure a plurality of configurations for the positioning target wireless device 602 to use, allowing the positioning target wireless device 602 to dynamically perform different levels of measurement/reporting on the set of positioning signals 624 transmitted by the set of positioning neighbor wireless devices 604 based on an operating scenario/condition, for example an environmental condition associated with the positioning target wireless device 602.

The positioning network entity 606 may transmit a capability request 610 to the positioning target wireless device 602. The positioning target wireless device 602 may receive the capability request 610. The capability request 610 may include an LPP message that includes a request for the positioning target wireless device 602 to indicate its capability to perform different kinds of measurements and/or report measurements in different ways. In other words, the capability request 610 may be transmitted by the positioning network entity 606 as part of an LPP annex (LPPa) protocol for positioning.

The positioning target wireless device 602 may transmit a capability 612 to the positioning network entity 606. The positioning network entity 606 may receive the capability 612 from the positioning target wireless device 602. The capability 612 may include one or more indicators of the capability of the positioning target wireless device 602 to dynamically alter how it measures/reports the set of positioning signals 624. The capability may include an indicator of subsampling criterion that the positioning target wireless device 602 may apply to measure the set of positioning signals 624, an indicator of subsampling resource criterion that the positioning target wireless device 602 may apply to measure the set of positioning signals 624, an indicator of a set of measurement formats that the positioning target wireless device 602 may use to report the measurements of the set of positioning signals 624, an indicator of a set of measurement attributes that the positioning target wireless device 602 may report, and/or an indicator of a set of measurement resolutions that the positioning target wireless device 602 may use to report the measurements of the set of positioning signals 624.

At 614, the positioning network entity 606 may configure a plurality of configurations for the positioning target wireless device 602. The positioning network entity 606 may configure the plurality of configurations based on the capability 612, for example by ensuring that the positioning target wireless device 602 is capable of measuring and reporting the set of positioning signals 624 for each of the plurality of configurations. The positioning network entity 606 may be configured to refrain from transmitting any configurations to the positioning target wireless device 602 that the positioning target wireless device 602 does not indicate that it can use based on the capability 612 received from the positioning target wireless device 602. In some aspects, the positioning network entity 606 may configure the plurality of configurations based on, for example, a targeted accuracy, a targeted maximum reporting overhead, a targeted maximum latency, and/or a targeted maximum power consumption.

The positioning network entity 606 may transmit the set of configurations 618 to the set of positioning neighbor wireless devices 604. The set of positioning neighbor wireless devices 604 may receive the set of configurations 618 from the positioning network entity 606. The set of configurations 618 may be applicable to each of the plurality of configurations configured by the positioning network entity 606 at 614. In other words, the set of configurations 618 may configure the set of positioning neighbor wireless devices 604 to transmit the set of positioning signals 624 at the positioning target wireless device 602 such that each of the plurality of configurations configured by the positioning network entity 606 at 614 may be applied by the positioning target wireless device 602. At 622, the set of positioning neighbor wireless devices 604 may apply the set of configurations 618. The set of positioning neighbor wireless devices 604 may transmit the set of positioning signals 624 at the positioning target wireless device 602 based on the set of configurations 618. The positioning target wireless device 602 may receive the set of positioning signals 624 from the set of positioning neighbor wireless devices 604.

The positioning network entity 606 may transmit the configurations 616 to the positioning target wireless device 602. The positioning target wireless device 602 may receive the configurations 616 from the positioning network entity 606. The configurations 616 may include the plurality of configurations that the positioning network entity 606 configured at 614. The configurations 616 may indicate a plurality of configurations for the positioning target wireless device 602 to select at 619.

At 619, the positioning target wireless device 602 may select a configuration from the plurality of configurations included in the configurations 616 received from the positioning network entity 606. The positioning target wireless device 602 may select the configuration based on an environmental condition associated with the positioning target wireless device 602. The environmental condition may be an attribute associated with the location of the positioning target wireless device 602. For example, the positioning target wireless device 602 may determine that there is a LOS path, or a mild NLOS path, between the set of positioning neighbor wireless devices 604 and the positioning target wireless device 602 by calculating an RSRP of the set of positioning signals 624 and determining that each RSRP of the set of positioning signals 624 is greater or equal to a threshold value. In response to the determination that there is a LOS path, or a mild NLOS path, between the set of positioning neighbor wireless devices 604 and the positioning target wireless device 602, the positioning target wireless device 602 may select one or more classes associated with the determination (e.g., a first configuration). For example, a set of classes may be associated with a minimum RSRP value. In another example, the positioning target wireless device 602 may determine that there is a strong NLOS path between the set of positioning neighbor wireless devices 604 and the positioning target wireless device 602 by calculating an RSRP of the set of positioning signals 624 and determining that at least one RSRP of the set of positioning signals 624 is less than or equal to a threshold value. In response to the determination that there is a strong NLOS path, between at least one of the set of positioning neighbor wireless devices 604 and the positioning target wireless device 602, the positioning target wireless device 602 may select one or more classes associated with the determination (e.g., a second configuration different from the first configuration). For example, a set of classes may be associated with a maximum RSRP value. In another example, the positioning target wireless device 602 may determine that there is a strong NLOS path between at least one of the set of positioning neighbor wireless devices 604 and the positioning target wireless device 602, and a LOS path, or a mild NLOS path between at least one of the set of positioning neighbor wireless devices 604 and the positioning target wireless device 602. In response, the positioning target wireless device 602 may select a first set of classes to measure/report the set of positioning signals 624 from the at least one of the set of positioning neighbor wireless devices 604 that have a LOS path, or a mild NLOS path, between the at least one of the set of positioning neighbor wireless devices 604 and the positioning target wireless device 602, and may select a second set of classes to measure/report the set of positioning signals 624 from the at least one of the set of positioning neighbor wireless devices 604 that have a strong NLOS path between the at least one of the set of positioning neighbor wireless devices 604 and the at least one of the set of positioning neighbor wireless devices 604.

At 620, the positioning target wireless device 602 may apply the selected configuration. The configuration may indicate a set of subsampling measurement criterion for the positioning target wireless device 602 to use. The subsampling measurement criterion may include a maximum number of sample measurements, a maximum number of paths, a ranking of sample measurements associated with a metric, a threshold value associated with the metric, a sample window size, or a measurement type. In one aspect, the subsampling measurement criterion may indicate to the positioning target wireless device 602 to select up to a number (e.g., N1) samples in a CIR or a CFR. In another aspect, the subsampling measurement criterion may indicate to the positioning target wireless device 602 to select up to a number (e.g., N1) of paths calculated based on a CIR or a CFR. In another aspect, the subsampling measurement criterion may indicate to the positioning target wireless device 602 to rank the measurements by a metric (e.g., power, delay, timing, frequency) in a CIR or a CFR. In another aspect, the subsampling measurement criterion may indicate to the positioning target wireless device 602 to retain a number (e.g., N1) of the top samples of a metric. (e.g., top N1 of the measurements having the lowest delay) In another aspect, the subsampling measurement criterion may indicate to the positioning target wireless device 602 to retain samples that satisfy a threshold (e.g., magnitude, power, phase) value. A threshold value may be, for example, a number of decibels (dB) below a maximum value, a number of dB above a mean of median values, a number of dB below a mean of median values, or a percentage of a maximum value (e.g., timing information/delay information). In another aspect, the subsampling measurement criterion may indicate to the positioning target wireless device 602 to retain up to a number (e.g., N1) of the top samples whose metric satisfies the threshold value in a CIR or a CFR. In another aspect, the subsampling measurement criterion may indicate to the positioning target wireless device 602 to reduce a sample window to a sample window size. The positioning target wireless device 602 may consider a window of a number (e.g., N1) contiguous samples, and find a first sample in the CIR or CFR that satisfies the threshold value. The positioning target wireless device 602 may then truncate the CIR/CFR with the window starting at the first sample, and retain a number (e.g., N2) of the top samples of a metric in the truncated window. In another aspect, the subsampling measurement criterion may indicate to the positioning target wireless device 602 to truncate the CIR/CFR with the window starting at the first sample, and retain a number (e.g., N2) of samples whose metric satisfies the threshold within the truncated CIR/CFR. In another aspect, the subsampling measurement criterion may indicate to the positioning target wireless device 602 to consider a window of a number (e.g., N1) contiguous samples, and find a second sample in the CIR or CFR whose magnitude is maximum within the N1 contiguous samples. The positioning target wireless device 602 may then truncate the CIR/CFR with the window centered around the second sample, and retain a number (e.g., N2) of the top samples of a metric in the truncated window. In another aspect, the subsampling measurement criterion may indicate to the positioning target wireless device 602 to truncate the CIR/CFR with the window centered around the second sample, and retain a number (e.g., N2) of samples whose metric satisfies the threshold within the truncated CIR/CFR. The positioning target wireless device 602 may report measurements that correspond with the N1 samples or N2 samples of the CIR/CFR/truncated CIR/truncated CFR. In another aspect, the subsampling measurement criterion may indicate to the positioning target wireless device 602 a type of measurement to collect, for example a CFR, a CIR, a PDP, a DP, or a multipath measurement type (e.g., multi-RTT, RSRPP, TDOA).

The configuration may indicate a set of subsampling resource criterion for the positioning target wireless device 602 to use. The subsampling resource criterion may include a range of a number of TRPs associated with the set of positioning signals 624, a range of a number of positioning signal resources (e.g., PRS resources) associated with the set of positioning signals 624, a set of TRP IDs associated with the set of positioning signals 624, a set of positioning signal resource IDs associated with the set of positioning signals 624, a selection of a set of TRPs associated with the set of positioning signals 624, and/or a selection of a set of positioning signal resources associated with the set of positioning signals 624. In one aspect, the subsampling resource criterion may indicate to the positioning target wireless device 602 to select between a minimum and a maximum number of TRPs that transmitted the set of positioning signals 624 at the positioning target wireless device 602 for the measurement at 626. In another aspect, the subsampling resource criterion may indicate to the positioning target wireless device 602 to select at least a minimum number of TRPs that transmitted the set of positioning signals 624 at the positioning target wireless device 602 for the measurement at 626. In another aspect, the subsampling resource criterion may indicate to the positioning target wireless device 602 to select at most a minimum number of TRPs that transmitted the set of positioning signals 624 at the positioning target wireless device 602 for the measurement at 626. In another aspect, the subsampling resource criterion may indicate to the positioning target wireless device 602 to select between a minimum and a maximum number of positioning signal resources (e.g., PRS resources) to measure for the set of positioning signals 624 for the measurement at 626. In another aspect, the subsampling resource criterion may indicate to the positioning target wireless device 602 to select at least a minimum number of positioning signal resources (e.g., PRS resources) to measure for the set of positioning signals 624 for the measurement at 626. In another aspect, the subsampling resource criterion may indicate to the positioning target wireless device 602 to select at most a maximum number of positioning signal resources (e.g., PRS resources) to measure for the set of positioning signals 624 for the measurement at 626. In another aspect, the subsampling resource criterion may indicate to the positioning target wireless device 602 to select a fixed number (e.g., N1) of TRPs from a set of TRPs indicated to the positioning target wireless device 602 for the measurement at 626. In another aspect, the subsampling resource criterion may indicate to the positioning target wireless device 602 to select a fixed number (e.g., N1) of positioning signal resources (e.g., PRS resources) from a set of positioning signal resources indicated to the positioning target wireless device 602 for the measurement at 626. In another aspect, the subsampling resource criterion may indicate to the positioning target wireless device 602 to select a fixed number (e.g., N1) of TRPs from any of the TRPs that transmitted the set of positioning signals 624 at the positioning target wireless device 602 for the measurement at 626. In another aspect, the subsampling resource criterion may indicate to the positioning target wireless device 602 to select a fixed number (e.g., N1) of positioning signal resources (e.g., PRS resources) from any of the positioning signal resources that are associated with the set of positioning signals 624 for the measurement at 626. In another aspect, the subsampling resource criterion may indicate to the positioning target wireless device 602 to select any TRPs from a set of TRPs indicated to the positioning target wireless device 602 for the measurement at 626. In another aspect, the subsampling resource criterion may indicate to the positioning target wireless device 602 to select any positioning signal resources from a set of positioning signal resources (e.g., PRS resources) indicated to the positioning target wireless device 602 for the measurement at 626.

The configuration may indicate a set of measurement formats for the positioning target wireless device 602 to use. The set of measurement formats may include at least one of a first bitmap of a measurement attribute, a first encoding of the measurement attribute, a differential encoding of the measurement attribute, or a second bitmap of a second encoding of the measurement attribute. In one aspect, a measurement format may be a bitmap of CIR timing information. For example, a CIR measurement may be represented by Abs (CIR)=[0.9, 0.6, 0.4, 0.1, 0.2, 0.44, 0.88, 0.76] (i.e., magnitude information at each time domain) and Arg (CIR)=[1.1, 1.2, 0.8, 2.1, 3.1, 0.01, 0.66, 1.60] (i.e., phase information at each time domain). While the vectors above have eight samples each, a vector may have more or less samples, for example 4K samples. A bitmap of timing information may be represented as a bit representation for CIR indexes whose magnitude is above a 0.25 threshold, or [1, 1, 1, 0, 0, 1, 1, 1], since Abs (CIR)=[0.9, 0.6, 0.4, 0.1, 0.2, 0.44, 0.88, 0.76]. Each bit may represent a quantized timing information (e.g., 10 nanoseconds (ns) for 100 megahertz (MHz) or 3 ns for 100 MHz). In one aspect, a measurement format may be a bitmap of CIR phase information. For example, the CIR measurement represented by Abs (CIR)=[0.9, 0.6, 0.4, 0.1, 0.2, 0.44, 0.88, 0.76] and Arg (CIR)=[1.1, 1.2, 0.8, 2.1, 3.1, 0.01, 0.66, 1.60] may have a bitmap of phase information represented as a bit representation for CIR indexes whose phase is above a 1 threshold, or [1, 1, 0, 1, 1, 0, 0, 1], since Arg (CIR)=[1.1, 1.2, 0.8, 2.1, 3.1, 0.01, 0.66, 1.60]. In another aspect, a measurement format may be a bitmap of CFR information. In another aspect, a measurement format may be an encoding of timing information. For example, the magnitude of a CIR measurement may be represented by Abs (CIR)=[0.9, 0.6, 0.4, 0.1, 0.2, 0.44, 0.88, 0.76]. A bitmap of timing information may be represented as an encoding where one bit of 0 represents a magnitude of x<0.25, two bits of 01 represents a magnitude within the range of 0.25≤x<0.5, two bits of 10 represents a magnitude within the range of 0.5≤x<0.75, and two bits of 11 represents a magnitude within the range of 0.75≤x<1.0. In other words, an encoded bit representation for CIR indexes whose magnitude is above a 0.25 threshold may be [11, 10, 01, 0, 0, 01, 11, 11], since Abs (CIR)=[0.9, 0.6, 0.4, 0.1, 0.2, 0.44, 0.88, 0.76]. In another aspect, a measurement format may be an encoding of frequency information. In another aspect, a measurement format may be an encoding of a quantized magnitude (e.g., power). In another aspect, a measurement format may be an encoding of a quantized angle (e.g., phase). In another aspect, a measurement format may be an encoding of a quantized magnitude and an encoding of a quantized angle. In another aspect, a measurement format may be a differential encoding of timing information. In another aspect, a measurement format may be a differential encoding of frequency information. In another aspect, a measurement format may be a differential encoding of a quantized magnitude. In another aspect, a measurement format may be a differential encoding of a quantized angle. In another aspect, a measurement format may be a differential encoding of a quantized magnitude and a differential encoding of a quantized angle. In another aspect, a measurement format may be a hybrid bitmap and encoding of CIR timing information. For example, the positioning target wireless device 602 may be configured to index timing information with a bitmap, where indexes corresponding to the timing information that do not satisfy a threshold range are set to zero while indexes corresponding to the timing information that satisfy the threshold range may be encoded (or differentially encoded) to represent the quantized magnitude and/or quantized angle information.

In some aspects, a general bitmap with encoding of fine timing information (e.g., 3 ns for 100 MHz), magnitude, and phase, may be represented by:

Xⱼ Xⱼ Xⱼ: Bit map for fine/fractional timing info with respect to bit j timing
Yⱼ Yⱼ Yⱼ: Bit map for magnitude (power) info of bit j
Zⱼ Zⱼ Zⱼ: Bit map for phase info of bit j
0: if the sample has negligible contribution (e.g., below threshold) to reporting

For example, such a bitmap of eight samples where the second and fourth samples exceed a threshold value may be represented by 0X₂X₂X₂Y₂Y₂Y₂Z₂Z₂Z₂0X₄X₄X₄Y₄Y₄Y₄Z₄Z₄Z₄0000.

The configuration may indicate a set of measurement attributes for the positioning target wireless device 602 to use. The set of measurement attributes may include at least one of timing information, frequency information, magnitude information, or angle information. In one aspect, a measurement attribute may include timing information of a CIR that correspond to measurements at the positioning target wireless device 602. For example, the timing information may correspond to multipath information whose measured power satisfies a threshold value. In another aspect, a measurement attribute may include frequency information of CFR that correspond to measurements at the positioning target wireless device 602. For example, the frequency information may correspond to subcarrier information whose measured power satisfies a threshold. In another aspect, a measurement attribute may include a magnitude (e.g., power) of a CIR/CFR corresponding to a measurement. In another aspect, a measurement attribute may include an angle (e.g., phase) of a CIR/CFR corresponding to a measurement. In another aspect, a measurement attribute may include a combination of the above (e.g., timing/frequency information, magnitude, and angle of CIR/CFR correspond to a measurement).

The configuration may indicate a set of measurement resolutions for the positioning target wireless device 602 to use. The set of measurement resolutions may include at least one of a first oversampling factor associated with an FFT, or a second oversampling factor associated with an IFFT. In other words, the positioning target wireless device 602 may be configured to apply oversampling to a CIR/CFR before reporting the measurement, or before applying subsampling.

At 626, the positioning target wireless device 602 may measure the set of positioning signals 624 based on the selected configuration at 619. In other words, the positioning target wireless device 602 may measure more, less, or different types of measurements based on the selected configuration at 619. The positioning target wireless device 602 may transmit a set of reports 628 based on the selected configuration at 619. In other words, the positioning target wireless device may report more, less, different types of measurements/calculations (e.g., calculation of intermediate measurements, calculations of locations), or use different types of formats for the report based on the selected configuration at 619. The positioning target wireless device 602 may transmit the set of reports 628 to at least one of the set of positioning neighbor wireless devices 604. At least one of the set of positioning neighbor wireless devices 604 may receive the set of reports 628. The at least one of the set of positioning neighbor wireless devices 604 that received the set of reports 628 may calculate a position/location of the positioning target wireless device 602 based on the set of reports 628, or may aggregate the report with other reports to use for a calculation of the position/location of the positioning target wireless device 602. The positioning target wireless device 602 may transmit the set of reports 628 to the positioning network entity 606. The positioning network entity 606 may receive the set of reports 628. The positioning network entity 606 may calculate a position/location of the positioning target wireless device 602 based on the set of reports 628, or may aggregate the report with other reports to use for a calculation of the position/location of the positioning target wireless device 602.

At 630, the positioning network entity 606 may process the set of reports 628, for example by parsing the measurements and using them to calculate a location of the positioning target wireless device 602, or to calculate an intermediate measurement that may be used to calculate a location of the positioning target wireless device 602. The set of reports 628 may include an indicator of the configuration selected by the positioning target wireless device 602 at 619 (e.g., a configuration ID that identifies a configuration from a plurality of configurations), and/or an indicator of an environmental condition that influenced the positioning target wireless device 602 to select the configuration at 619 (e.g., an indicator of whether there is a strong LOS between the positioning target wireless device 602 and the set of positioning neighbor wireless devices 604). The positioning network entity 606 may feed the measurements from the set of reports 628 into a positioning model to calculate the location of the positioning target wireless device 602, or to calculate the intermediate measurement.

In this manner, the positioning target wireless device 602 may dynamically increase/decrease the overhead for collecting measurements and/or reporting measurements at the positioning target wireless device 602 based on configuration options provided by the positioning target wireless device 602 and a set of environmental conditions at the positioning target wireless device 602.

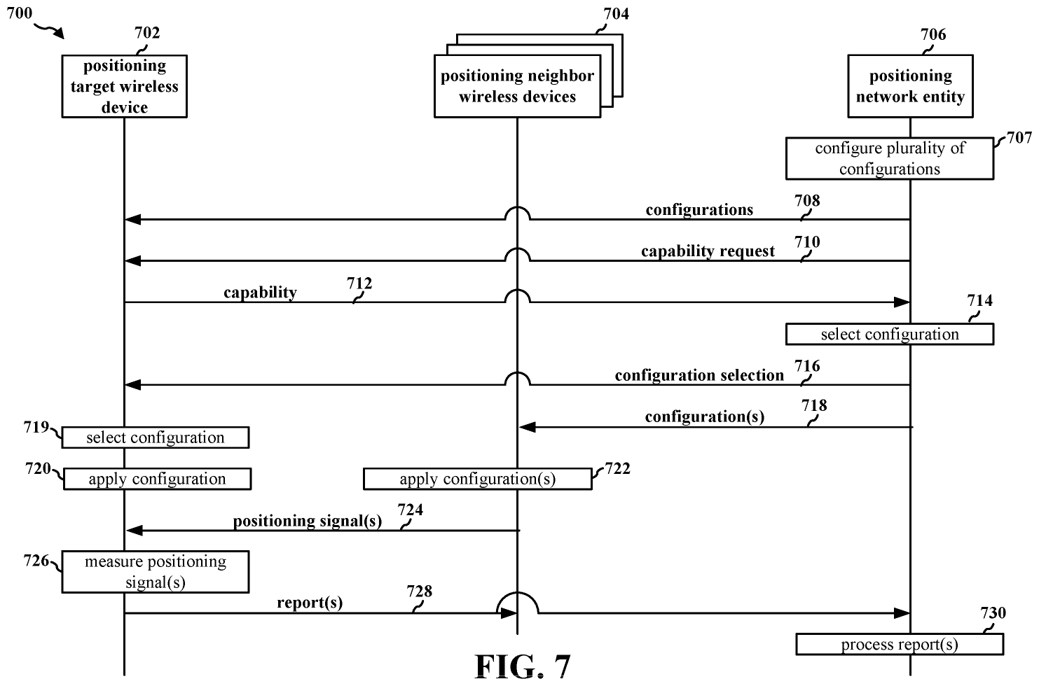

FIG. 7 is a connection flow diagram 700 illustrating an example of communications between a positioning target wireless device 702, a set of positioning neighbor wireless devices 704, and a positioning network entity 706. The positioning target wireless device 702 may be a UE. The set of positioning neighbor wireless devices 704 may include a set of base stations and/or a set of TRPs configured to transmit positioning signals at the positioning target wireless device 702. The positioning network entity 706 may include an LMF, or may include one or more location servers. The positioning network entity 706 may be configured to configure positioning occasions between the positioning target wireless device 702 and the set of positioning neighbor wireless devices 704. The positioning network entity 706 may be configured to configure a set of measurement/reporting classes that allow the positioning target wireless device 702 to perform dynamic reporting of measurements of the set of positioning signals 724 transmitted by the set of positioning neighbor wireless devices 704. A measurement reporting class may also be referred to as a configuration. In other words, the positioning network entity 706 may configure a plurality of configurations for the positioning target wireless device 702 to use, allowing the positioning target wireless device 702 to dynamically perform different levels of measurement/reporting on the set of positioning signals 724 transmitted by the set of positioning neighbor wireless devices 704 based on an operating scenario/condition, for example an environmental condition associated with the positioning target wireless device 702.

At 707, the positioning network entity 706 may configure a plurality of configurations for the positioning target wireless device 702. The positioning network entity 706 may configure a plurality of configurations for a plurality of UEs for positioning with positioning neighbor wireless devices, such as the set of positioning neighbor wireless devices 704. The positioning network entity 706 may transmit the configurations 708 to a plurality of UEs, one of which is the positioning target wireless device 702. The positioning target wireless device 702 may receive the configurations 708 from the positioning network entity 706.

The positioning network entity 706 may transmit a capability request 710 to the positioning target wireless device 702. The positioning target wireless device 702 may receive the capability request 710. The capability request 710 may include an LPP message that includes a request for the positioning target wireless device 702 to indicate its capability to perform different kinds of measurements and/or report measurements in different ways. In other words, the capability request 710 may be transmitted by the positioning network entity 706 as part of an LPP annex (LPPa) protocol for positioning.

The positioning target wireless device 702 may transmit a capability 712 to the positioning network entity 706. The positioning network entity 706 may receive the capability 712 from the positioning target wireless device 702. The capability 712 may include one or more indicators of the capability of the positioning target wireless device 702 to dynamically alter how it measures/reports the set of positioning signals 724. The capability may include an indicator of subsampling criterion that the positioning target wireless device 702 may apply to measure the set of positioning signals 724, an indicator of subsampling resource criterion that the positioning target wireless device 702 may apply to measure the set of positioning signals 724, an indicator of a set of measurement formats that the positioning target wireless device 702 may use to report the measurements of the set of positioning signals 724, an indicator of a set of measurement attributes that the positioning target wireless device 702 may report, and/or an indicator of a set of measurement resolutions that the positioning target wireless device 702 may use to report the measurements of the set of positioning signals 724.

At 714, the positioning network entity 706 may select one or more configurations, or a subset of configurations, from the configurations 708 transmitted to the positioning target wireless device 702. The positioning network entity 706 may select the subset of configurations based on the capability 712 received from the positioning target wireless device 702. The positioning network entity 706 may select the subset of configurations such that each of the subset of configurations can be used by the positioning target wireless device 702 based on the capability 712 received from the positioning target wireless device 702. In some aspects, the positioning network entity 706 may select the subset of configurations based on one or more environmental conditions associated with the positioning target wireless device 702, for example an indication of whether a LOS path between the positioning target wireless device 702 and the set of positioning neighbor wireless devices 704 exists. In some aspects, the positioning network entity 706 may select the subset of configurations based on, for example, a targeted accuracy, a targeted maximum reporting overhead, a targeted maximum latency, and/or a targeted maximum power consumption.

The positioning network entity 706 may transmit the configuration selection 716 to the positioning target wireless device 702. The positioning target wireless device 702 may receive the configuration selection 716 from the positioning network entity 706. The configuration selection 716 may indicate a selection of a set of configurations. The set of configurations may include one or more configurations. The configuration selection 716 may include a selection of the plurality of configurations from the configurations 708 received from the positioning network entity 706. The configuration selection 716 may include an indicator of a selection of a subset of configurations from the configurations 708 transmitted to the positioning target wireless device 702. The capability 712 may indicate a subset of the configurations 708 to the positioning network entity 706. The configuration selection 716 may indicate a smaller subset of the subset of the configurations indicated by the capability 712. The positioning target wireless device 702 may then select from the subset of the plurality of configurations indicated by the capability 712 at 719.

The positioning network entity 706 may transmit the set of configurations 718 to the set of positioning neighbor wireless devices 704. The set of positioning neighbor wireless devices 704 may receive the set of configurations 718 from the positioning network entity 706. The set of configurations 718 may be applicable to each of the subset of configurations indicated in the configuration selection 716. In other words, the set of configurations 718 may configure the set of positioning neighbor wireless devices 704 to transmit the set of positioning signals 724 at the positioning target wireless device 702 such that each of the subset of configurations indicated in the configuration selection 716 may be applied by the positioning target wireless device 702. At 722, the set of positioning neighbor wireless devices 704 may apply the set of configurations 718. The set of positioning neighbor wireless devices 704 may transmit the set of positioning signals 724 at the positioning target wireless device 702 based on the set of configurations 718. The positioning target wireless device 702 may receive the set of positioning signals 724 from the set of positioning neighbor wireless devices 704.

At 719, the positioning target wireless device 702 may select a set of configurations from the plurality of configurations included in the configurations 708 received from the positioning network entity 706 based on the configuration selection 716 received from the positioning network entity 706. In some aspects, where the configuration selection 716 indicates more than one configuration, the positioning target wireless device 702 may further select a single configuration based on an environmental condition associated with the positioning target wireless device 702.

At 720, the positioning target wireless device 702 may apply the selected configuration. The configuration may indicate a set of subsampling measurement criterion for the positioning target wireless device 702 to use. The subsampling measurement criterion may include a maximum number of sample measurements, a maximum number of paths, a ranking of sample measurements associated with a metric, a threshold value associated with the metric, a sample window size, or a measurement type. In one aspect, the subsampling measurement criterion may indicate to the positioning target wireless device 702 to select up to a number (e.g., N1) samples in a CIR or a CFR. In another aspect, the subsampling measurement criterion may indicate to the positioning target wireless device 702 to select up to a number (e.g., N1) of paths calculated based on a CIR or a CFR. In another aspect, the subsampling measurement criterion may indicate to the positioning target wireless device 702 to rank the measurements by a metric (e.g., power, delay, timing, frequency) in a CIR or a CFR. In another aspect, the subsampling measurement criterion may indicate to the positioning target wireless device 702 to retain a number (e.g., N1) of the top samples of a metric. (e.g., top N1 of the measurements having the lowest delay) In another aspect, the subsampling measurement criterion may indicate to the positioning target wireless device 702 to retain samples that satisfy a threshold (e.g., magnitude, power, phase) value. A threshold value may be, for example, a number of decibels (dB) below a maximum value, a number of dB above a mean of median values, a number of dB below a mean of median values, or a percentage of a maximum value (e.g., timing information/delay information). In another aspect, the subsampling measurement criterion may indicate to the positioning target wireless device 702 to retain up to a number (e.g., N1) of the top samples whose metric satisfies the threshold value in a CIR or a CFR. In another aspect, the subsampling measurement criterion may indicate to the positioning target wireless device 702 to reduce a sample window to a sample window size. The positioning target wireless device 702 may consider a window of a number (e.g., N1) contiguous samples, and find a first sample in the CIR or CFR that satisfies the threshold value. The positioning target wireless device 702 may then truncate the CIR/CFR with the window starting at the first sample, and retain a number (e.g., N2) of the top samples of a metric in the truncated window. In another aspect, the subsampling measurement criterion may indicate to the positioning target wireless device 702 to truncate the CIR/CFR with the window starting at the first sample, and retain a number (e.g., N2) of samples whose metric satisfies the threshold within the truncated CIR/CFR. In another aspect, the subsampling measurement criterion may indicate to the positioning target wireless device 702 to consider a window of a number (e.g., N1) contiguous samples, and find a second sample in the CIR or CFR whose magnitude is maximum within the N1 contiguous samples. The positioning target wireless device 702 may then truncate the CIR/CFR with the window centered around the second sample, and retain a number (e.g., N2) of the top samples of a metric in the truncated window. In another aspect, the subsampling measurement criterion may indicate to the positioning target wireless device 702 to truncate the CIR/CFR with the window centered around the second sample, and retain a number (e.g., N2) of samples whose metric satisfies the threshold within the truncated CIR/CFR. The positioning target wireless device 702 may report measurements that correspond with the N1 samples or N2 samples of the CIR/CFR/truncated CIR/truncated CFR. In another aspect, the subsampling measurement criterion may indicate to the positioning target wireless device 702 a type of measurement to collect, for example a CFR, a CIR, a PDP, a DP, or a multipath measurement type (e.g., multi-RTT, RSRPP, TDOA).

The configuration may indicate a set of subsampling resource criterion for the positioning target wireless device 702 to use. The subsampling resource criterion may include a range of a number of TRPs associated with the set of positioning signals 724, a range of a number of positioning signal resources (e.g., PRS resources) associated with the set of positioning signals 724, a set of TRP IDs associated with the set of positioning signals 724, a set of positioning signal resource IDs associated with the set of positioning signals 724, a selection of a set of TRPs associated with the set of positioning signals 724, and/or a selection of a set of positioning signal resources associated with the set of positioning signals 724. In one aspect, the subsampling resource criterion may indicate to the positioning target wireless device 702 to select between a minimum and a maximum number of TRPs that transmitted the set of positioning signals 724 at the positioning target wireless device 702 for the measurement at 726. In another aspect, the subsampling resource criterion may indicate to the positioning target wireless device 702 to select at least a minimum number of TRPs that transmitted the set of positioning signals 724 at the positioning target wireless device 702 for the measurement at 726. In another aspect, the subsampling resource criterion may indicate to the positioning target wireless device 702 to select at most a minimum number of TRPs that transmitted the set of positioning signals 724 at the positioning target wireless device 702 for the measurement at 726. In another aspect, the subsampling resource criterion may indicate to the positioning target wireless device 702 to select between a minimum and a maximum number of positioning signal resources (e.g., PRS resources) to measure for the set of positioning signals 724 for the measurement at 726. In another aspect, the subsampling resource criterion may indicate to the positioning target wireless device 702 to select at least a minimum number of positioning signal resources (e.g., PRS resources) to measure for the set of positioning signals 724 for the measurement at 726. In another aspect, the subsampling resource criterion may indicate to the positioning target wireless device 702 to select at most a maximum number of positioning signal resources (e.g., PRS resources) to measure for the set of positioning signals 724 for the measurement at 726. In another aspect, the subsampling resource criterion may indicate to the positioning target wireless device 702 to select a fixed number (e.g., N1) of TRPs from a set of TRPs indicated to the positioning target wireless device 702 for the measurement at 726. In another aspect, the subsampling resource criterion may indicate to the positioning target wireless device 702 to select a fixed number (e.g., N1) of positioning signal resources (e.g., PRS resources) from a set of positioning signal resources indicated to the positioning target wireless device 702 for the measurement at 726. In another aspect, the subsampling resource criterion may indicate to the positioning target wireless device 702 to select a fixed number (e.g., N1) of TRPs from any of the TRPs that transmitted the set of positioning signals 724 at the positioning target wireless device 702 for the measurement at 726. In another aspect, the subsampling resource criterion may indicate to the positioning target wireless device 702 to select a fixed number (e.g., N1) of positioning signal resources (e.g., PRS resources) from any of the positioning signal resources that are associated with the set of positioning signals 724 for the measurement at 726. In another aspect, the subsampling resource criterion may indicate to the positioning target wireless device 702 to select any TRPs from a set of TRPs indicated to the positioning target wireless device 702 for the measurement at 726. In another aspect, the subsampling resource criterion may indicate to the positioning target wireless device 702 to select any positioning signal resources from a set of positioning signal resources (e.g., PRS resources) indicated to the positioning target wireless device 702 for the measurement at 726.

The configuration may indicate a set of measurement formats for the positioning target wireless device 702 to use. The set of measurement formats may include at least one of a first bitmap of a measurement attribute, a first encoding of the measurement attribute, a differential encoding of the measurement attribute, or a second bitmap of a second encoding of the measurement attribute. In one aspect, a measurement format may be a bitmap of CIR timing information. For example, a CIR measurement may be represented by Abs (CIR)=[0.9, 0.6, 0.4, 0.1, 0.2, 0.44, 0.88, 0.76] (i.e., magnitude information at each time domain) and Arg (CIR)=[1.1, 1.2, 0.8, 2.1, 3.1, 0.01, 0.66, 1.60] (i.e., phase information at each time domain). While the vectors above have eight samples each, a vector may have more or less samples, for example 4K samples. A bitmap of timing information may be represented as a bit representation for CIR indexes whose magnitude is above a 0.25 threshold, or [1, 1, 1, 0, 0, 1, 1, 1], since Abs (CIR)=[0.9, 0.6, 0.4, 0.1, 0.2, 0.44, 0.88, 0.76]. Each bit may represent a quantized timing information (e.g., 10 nanoseconds (ns) for 100 megahertz (MHz) or 3 ns for 100 MHz). In one aspect, a measurement format may be a bitmap of CIR phase information. For example, the CIR measurement represented by Abs (CIR)=[0.9, 0.6, 0.4, 0.1, 0.2, 0.44, 0.88, 0.76] and Arg (CIR)=[1.1, 1.2, 0.8, 2.1, 3.1, 0.01, 0.66, 1.60] may have a bitmap of phase information represented as a bit representation for CIR indexes whose phase is above a 1 threshold, or [1, 1, 0, 1, 1, 0, 0, 1], since Arg (CIR)=[1.1, 1.2, 0.8, 2.1, 3.1, 0.01, 0.66, 1.60]. In another aspect, a measurement format may be a bitmap of CFR information. In another aspect, a measurement format may be an encoding of timing information. For example, the magnitude of a CIR measurement may be represented by Abs (CIR)=[0.9, 0.6, 0.4, 0.1, 0.2, 0.44, 0.88, 0.76]. A bitmap of timing information may be represented as an encoding where one bit of 0 represents a magnitude of x<0.25, two bits of 01 represents a magnitude within the range of 0.25≤x<0.5, two bits of 10 represents a magnitude within the range of 0.5≤x<0.75, and two bits of 11 represents a magnitude within the range of 0.75≤x<1.0. In other words, an encoded bit representation for CIR indexes whose magnitude is above a 0.25 threshold may be [11, 10, 01, 0, 0, 01, 11, 11], since Abs (CIR)=[0.9, 0.6, 0.4, 0.1, 0.2, 0.44, 0.88, 0.76]. In another aspect, a measurement format may be an encoding of frequency information. In another aspect, a measurement format may be an encoding of a quantized magnitude (e.g., power). In another aspect, a measurement format may be an encoding of a quantized angle (e.g., phase). In another aspect, a measurement format may be an encoding of a quantized magnitude and an encoding of a quantized angle. In another aspect, a measurement format may be a differential encoding of timing information. In another aspect, a measurement format may be a differential encoding of frequency information. In another aspect, a measurement format may be a differential encoding of a quantized magnitude. In another aspect, a measurement format may be a differential encoding of a quantized angle. In another aspect, a measurement format may be a differential encoding of a quantized magnitude and a differential encoding of a quantized angle. In another aspect, a measurement format may be a hybrid bitmap and encoding of CIR timing information. For example, the positioning target wireless device 702 may be configured to index timing information with a bitmap, where indexes corresponding to the timing information that do not satisfy a threshold range are set to zero while indexes corresponding to the timing information that satisfy the threshold range may be encoded (or differentially encoded) to represent the quantized magnitude and/or quantized angle information.

In some aspects, a general bitmap with encoding of fine timing information (e.g., 3 ns for 100 MHz), magnitude, and phase, may be represented by:

Xⱼ Xⱼ Xⱼ: Bit map for fine/fractional timing info with respect to bit j timing
Yⱼ Yⱼ Yⱼ: Bit map for magnitude (power) info of bit j
Zⱼ Zⱼ Zⱼ: Bit map for phase info of bit j
0: if the sample has negligible contribution (e.g., below threshold) to reporting

For example, such a bitmap of eight samples where the second and fourth samples exceed a threshold value may be represented by 0X₂X₂X₂Y₂Y₂Y₂Z₂Z₂Z₂0X₄X₄X₄Y₄Y₄Y₄Z₄Z₄Z₄0000.

The configuration may indicate a set of measurement attributes for the positioning target wireless device 702 to use. The set of measurement attributes may include at least one of timing information, frequency information, magnitude information, or angle information. In one aspect, a measurement attribute may include timing information of a CIR that correspond to measurements at the positioning target wireless device 702. For example, the timing information may correspond to multipath information whose measured power satisfies a threshold value. In another aspect, a measurement attribute may include frequency information of CFR that correspond to measurements at the positioning target wireless device 702. For example, the frequency information may correspond to subcarrier information whose measured power satisfies a threshold. In another aspect, a measurement attribute may include a magnitude (e.g., power) of a CIR/CFR corresponding to a measurement. In another aspect, a measurement attribute may include an angle (e.g., phase) of a CIR/CFR corresponding to a measurement. In another aspect, a measurement attribute may include a combination of the above (e.g., timing/frequency information, magnitude, and angle of CIR/CFR correspond to a measurement).

The configuration may indicate a set of measurement resolutions for the positioning target wireless device 702 to use. The set of measurement resolutions may include at least one of a first oversampling factor associated with an FFT, or a second oversampling factor associated with an IFFT. In other words, the positioning target wireless device 702 may be configured to apply oversampling to a CIR/CFR before reporting the measurement, or before applying subsampling.

At 726, the positioning target wireless device 702 may measure the set of positioning signals 724 based on the selected configuration at 719. In other words, the positioning target wireless device 702 may measure more, less, or different types of measurements based on the selected configuration at 719. The positioning target wireless device 702 may transmit a set of reports 728 based on the selected configuration at 719. In other words, the positioning target wireless device 702 may measure more, less, or different types of measurements based on the selected configuration at 719. The positioning target wireless device 702 may transmit the set of reports 728 to at least one of the set of positioning neighbor wireless devices 704. At least one of the set of positioning neighbor wireless devices 704 may receive the set of reports 728. The at least one of the set of positioning neighbor wireless devices 704 that received the set of reports 728 may calculate a position/location of the positioning target wireless device 702 based on the set of reports 728, or may aggregate the report with other reports to use for a calculation of the position/location of the positioning target wireless device 702. The positioning target wireless device 702 may transmit the set of reports 728 to the positioning network entity 706. The positioning network entity 706 may receive the set of reports 728. The positioning network entity 706 may calculate a position/location of the positioning target wireless device 702 based on the set of reports 728, or may aggregate the report with other reports to use for a calculation of the position/location of the positioning target wireless device 702.

At 730, the positioning network entity 706 may process the set of reports 728, for example by parsing the measurements and using them to calculate a location of the positioning target wireless device 702, or to calculate an intermediate measurement that may be used to calculate a location of the positioning target wireless device 702. The set of reports 728 may include an indicator of the configuration selected by the positioning target wireless device 702 at 719 (e.g., a configuration ID that identifies a configuration from a plurality of configurations), and/or an indicator of an environmental condition that influenced the positioning target wireless device 702 to select the configuration at 719 (e.g., an indicator of whether there is a strong LOS between the positioning target wireless device 702 and the set of positioning neighbor wireless devices 704). The positioning network entity 706 may feed the measurements from the set of reports 728 into a positioning model to calculate the location of the positioning target wireless device 702, or to calculate the intermediate measurement.

In this manner, the positioning network entity 706 may dynamically increase/decrease the overhead for collecting measurements at the positioning target wireless device 702 based on dynamic signaling to the positioning target wireless device 702 of selected measurement/reporting configurations.

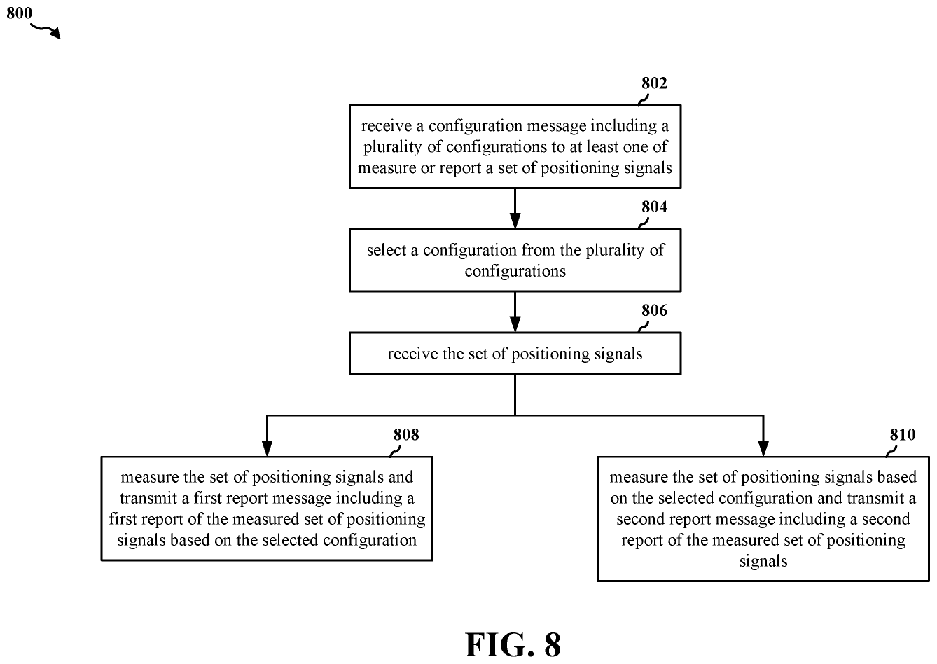

FIG. 8 is a flowchart 800 of a method of wireless communication. The method may be performed by a UE (e.g., the UE 104, the UE 350; the wireless device 404, the wireless device 504; the positioning target wireless device 602; the positioning target wireless device 702; the apparatus 1204). At 802, the UE may receive a configuration message including a plurality of configurations to at least one of measure or report a set of positioning signals. For example, 802 may be performed by the positioning target wireless device 602 in FIG. 6, which may receive the configurations 616 from the positioning network entity 606. The configurations 616 may include a plurality of configurations to at least one of measure or report the set of positioning signals 624 at the positioning target wireless device 602. Moreover, 802 may be performed by the component 198 in FIG. 1, 3, or 12.

At 804, the UE may select a configuration from the plurality of configurations. For example, 804 may be performed by the positioning target wireless device 602 in FIG. 6, which may, at 619, select a configuration from the plurality of configurations indicated in the configurations 616. Moreover, 804 may be performed by the component 198 in FIG. 1, 3, or 12.

At 806, the UE may receive the set of positioning signals. For example, 806 may be performed by the positioning target wireless device 602 in FIG. 6, which may receive the set of positioning signals 624 from the set of positioning neighbor wireless devices 604. Moreover, 806 may be performed by the component 198 in FIG. 1, 3, or 12.

At 808, the UE may measure the set of positioning signals and transmit a first report message including a first report of the measured set of positioning signals based on the selected configuration. For example, 808 may be performed by the positioning target wireless device 602 in FIG. 6, which may, at 626, measure the set of positioning signals 624 and transmit the set of reports 628 including a report of the measured set of positioning signals based on the selected configuration at 619. Moreover, 808 may be performed by the component 198 in FIG. 1, 3, or 12.

At 810, the UE may measure the set of positioning signals based on the selected configuration and transmit a second report message including a second report of the measured set of positioning signals. For example, 810 may be performed by the positioning target wireless device 602 in FIG. 6, which may, at 626, measure the set of positioning signals 624 based on the selected configuration and transmit the set of reports 628 including a report of the measured set of positioning signals. Moreover, 810 may be performed by the component 198 in FIG. 1, 3, or 12.

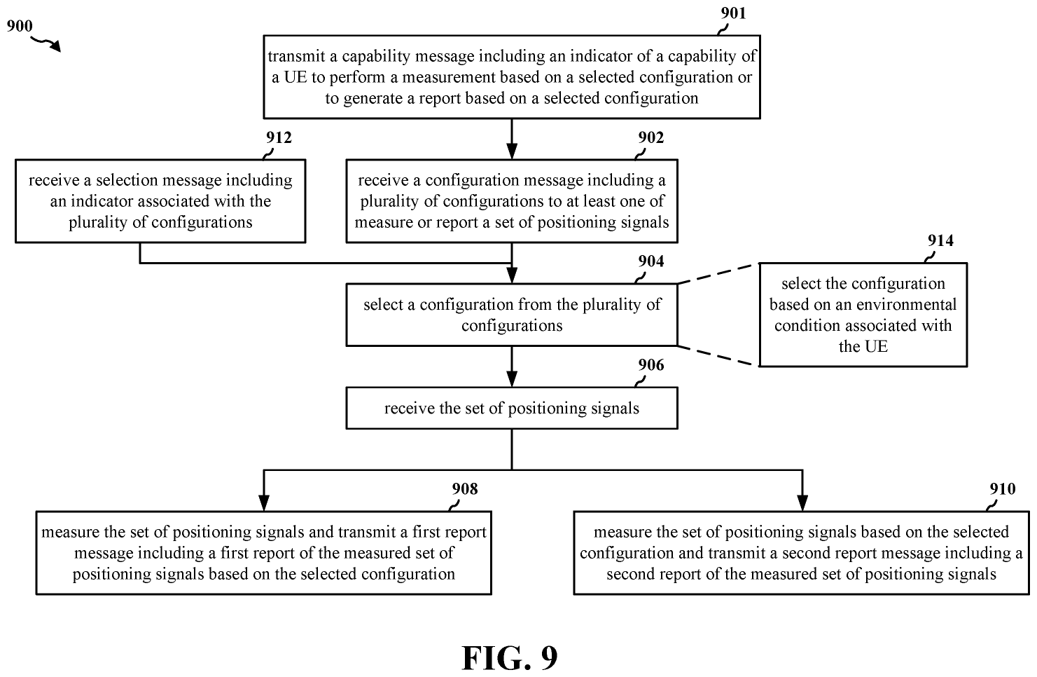

FIG. 9 is a flowchart 900 of a method of wireless communication. The method may be performed by a UE (e.g., the UE 104, the UE 350; the wireless device 404, the wireless device 504; the positioning target wireless device 602; the positioning target wireless device 702; the apparatus 1204).

At 901, the UE may transmit a capability message including an indicator of a capability of a UE to perform a measurement based on a selected configuration or to generate a report based on a selected configuration. The plurality of configurations may be based on the capability. For example, 901 may be performed by the positioning target wireless device 602 in FIG. 6, which may transmit a capability 612 to the positioning network entity 606. The positioning target wireless device 602 may transmit a capability message, for example an LPP message, including an indicator of the capability 612. The capability 612 may indicate that the positioning target wireless device 602 is capable of performing a measurement based on a selected configuration or is capable of generating a report based on a selected configuration. The positioning network entity 606 may select at least some of the configurations 616 based on the capability 612. Moreover, 901 may be performed by the component 198 in FIG. 1, 3, or 12.

At 902, the UE may receive a configuration message including a plurality of configurations to at least one of measure or report a set of positioning signals. For example, 902 may be performed by the positioning target wireless device 602 in FIG. 6, which may receive the configurations 616 from the positioning network entity 606. The configurations 616 may include a plurality of configurations to at least one of measure or report the set of positioning signals 624 at the positioning target wireless device 602. Moreover, 902 may be performed by the component 198 in FIG. 1, 3, or 12.

At 904, the UE may select a configuration from the plurality of configurations. The selected configuration may include at least one of a first indicator of a subsampling measurement criterion, a second indicator of a set of subsampling resource criterion, a third indicator of a set of measurement formats, a fourth indicator of a set of measurement attributes, or a fifth indicator of a set of measurement resolutions. The subsampling measurement criterion may include at least one of a maximum number of sample measurements, a maximum number of paths, a ranking of sample measurements associated with a metric, a threshold value associated with the metric, a sample window size, or a sixth indicator of a measurement type. The measurement type may include at least one of a CFR, a CIR, a PDP, a DP, or a multipath measurement type. The set of subsampling resource criterion may include at least one of a first range of a first number of TRPs associated with the set of positioning signals, a second range of a second number of positioning signal resources associated with the set of positioning signals, a set of TRP IDs associated with the set of positioning signals, a set of positioning signal resource IDs associated with the set of positioning signals, a first selection of a set of TRPs associated with the set of positioning signals, or a second selection of a set of positioning signal resources associated with the set of positioning signals. The set of measurement formats may include at least one of a first bitmap of a measurement attribute, a first encoding of the measurement attribute, a differential encoding of the measurement attribute, or a second bitmap of a second encoding of the measurement attribute. The set of measurement attributes may include at least one of timing information, frequency information, magnitude information, or angle information. The set of measurement resolutions may include at least one of a first oversampling factor associated with an FFT, or a second oversampling factor associated with an IFFT. For example, 904 may be performed by the positioning target wireless device 602 in FIG. 6, which may, at 619, select a configuration from the plurality of configurations indicated in the configurations 616. The configuration selected by the positioning target wireless device 602 at 619 may include (a), an indicator of a subsampling measurement criterion, (b) an indicator of a set of subsampling resource criterion, (c) an indicator of a set of measurement formats, (d) an indicator of a set of measurement attributes, and/or (c) an indicator of a set of measurement resolutions. The subsampling measurement criterion may include (a) a maximum number of sample measurements, (b) a maximum number of paths, (c) a ranking of sample measurements associated with a metric (e.g., bounded by the metric, selected using the metric), (d) a threshold value associated with the metric (e.g., bounded by the metric), (c) a sample window size, and/or (f) an indicator of a measurement type. The measurement type may include a CFR, a CIR, a PDP, a DP, and/or a multipath measurement type. The set of subsampling resource criterion may include (a) a range of a number of TRPs that transmitted the set of positioning signals 624, (b) a range of a number of positioning signal resources that the set of positioning signals 624 use, (c) a set of TRP IDs that identify the TRPs that transmit the set of positioning signals 624, (d) a set of positioning signal resource IDs that identify the positioning signal resources that the set of positioning signals 624 use, (e) a selection of a set of TRPs that transmit positioning signals that the positioning target wireless device 602 should measure, and/or (f) a selection of a set of positioning signal resources that the positioning target wireless device 602 should measure when measuring the set of positioning signals 624. The set of measurement formats may include (a) a bitmap of a measurement attribute. (b) an encoding of the measurement attribute, (c) a differential encoding of the measurement attribute, and/or (d) a bitmap of an encoding of the measurement attribute. The set of measurement attributes may include (a) timing information, (b) frequency information, (c) magnitude information, and/or (d) angle information for measuring the set of positioning signals 624. The set of measurement resolutions may include an oversampling factor associated with an FFT and/or an oversampling factor associated with an IFFT. Moreover, 904 may be performed by the component 198 in FIG. 1, 3, or 12.

At 906, the UE may receive the set of positioning signals. For example, 906 may be performed by the positioning target wireless device 602 in FIG. 6, which may receive the set of positioning signals 624 from the set of positioning neighbor wireless devices 604. Moreover, 906 may be performed by the component 198 in FIG. 1, 3, or 12.

At 908, the UE may measure the set of positioning signals and transmit a first report message including a first report of the measured set of positioning signals based on the selected configuration. The first report may include at least one of a first indicator of the selected configuration or a second indicator of the environmental condition associated with the UE. For example, 908 may be performed by the positioning target wireless device 602 in FIG. 6, which may, at 626, measure the set of positioning signals 624 and transmit the set of reports 628 including a report of the measured set of positioning signals based on the selected configuration at 619. The first report may include at least one of a first indicator of the configuration selected by the positioning target wireless device 602 at 619 or a second indicator of the environmental condition that the positioning target wireless device 602 used to select the configuration at 619. Moreover, 908 may be performed by the component 198 in FIG. 1, 3, or 12.

At 910, the UE may measure the set of positioning signals based on the selected configuration and transmit a second report message including a second report of the measured set of positioning signals. The second report may include at least one of a first indicator of the selected configuration or a second indicator of the environmental condition associated with the UE. For example, 910 may be performed by the positioning target wireless device 602 in FIG. 6, which may, at 626, measure the set of positioning signals 624 based on the selected configuration and transmit the set of reports 628 including a report of the measured set of positioning signals. The second report may include at least one of a first indicator of the configuration selected by the positioning target wireless device 602 at 619 or a second indicator of the environmental condition that the positioning target wireless device 602 used to select the configuration at 619. Moreover, 910 may be performed by the component 198 in FIG. 1, 3, or 12.

At 912, the UE may receive a selection message including an indicator associated with the plurality of configurations. For example, 912 may be performed by the positioning target wireless device 702 in FIG. 7, which may receive the configuration selection 716 from the positioning network entity 706. The positioning network entity 706 may transmit a selection message, for example an LPP message, including an indicator associated with selecting the plurality of configurations from the configurations 708. Moreover, 912 may be performed by the component 198 in FIG. 1.3, or 12.

At 914, the UE may select the configuration from the plurality of configurations by selecting the configuration based on an environmental condition associated with the UE. For example, 914 may be performed by the positioning target wireless device 602 in FIG. 6, which may, at 619, select the configuration based on an environmental condition associated with the positioning target wireless device 602, for example the presence or an absence of a strong LOS between the positioning target wireless device 602 and the set of positioning neighbor wireless devices 604. Moreover, 914 may be performed by the component 198 in FIG. 1, 3, or 12.

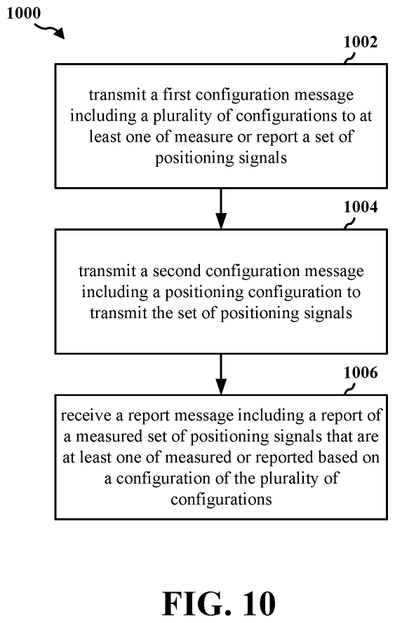

FIG. 10 is a flowchart 1000 of a method of wireless communication. The method may be performed by a network node (e.g., the base station 102, the base station 310; the wireless device 402, the wireless device 406, the wireless device 502, the wireless device 506; one of the set of positioning neighbor wireless devices 604, one of the set of positioning neighbor wireless devices 704; the positioning network entity 606, the positioning network entity 706; the network entity 1202, the network entity 1302, the network entity 1460). At 1002, the network node may transmit a first configuration message including a plurality of configurations to at least one of measure or report a set of positioning signals. For example, 1002 may be performed by the positioning network entity 606 in FIG. 6, which may transmit the configurations 616 to the positioning target wireless device 602. The configurations 616 may include a plurality of configurations to at least one of measure or report the set of positioning signals 624. Moreover, 1002 may be performed by the component 199 in FIG. 1, 3, 13, or 14.

At 1004, the network node may transmit a second configuration message including a positioning configuration to transmit the set of positioning signals. For example, 1004 may be performed by the positioning network entity 606 in FIG. 6, which may transmit the set of configurations 618 including a positioning configuration to transmit the set of positioning signals 624. Moreover, 1004 may be performed by the component 199 in FIG. 1, 3, 13, or 14.

At 1006, the network node may receive a report message including a report of a measured set of positioning signals that are at least one of measured or reported based on a configuration of the plurality of configurations. For example, 1006 may be performed by the positioning network entity 606 in FIG. 6, which may receive the set of reports 628 from the positioning target wireless device 602. The set of reports 628 may include a report of a measured set of positioning signals that are at least one of measured or reported based on a configuration of the plurality of configurations transmitted as the configurations 616. Moreover, 1006 may be performed by the component 199 in FIG. 1, 3, 13, or 14.

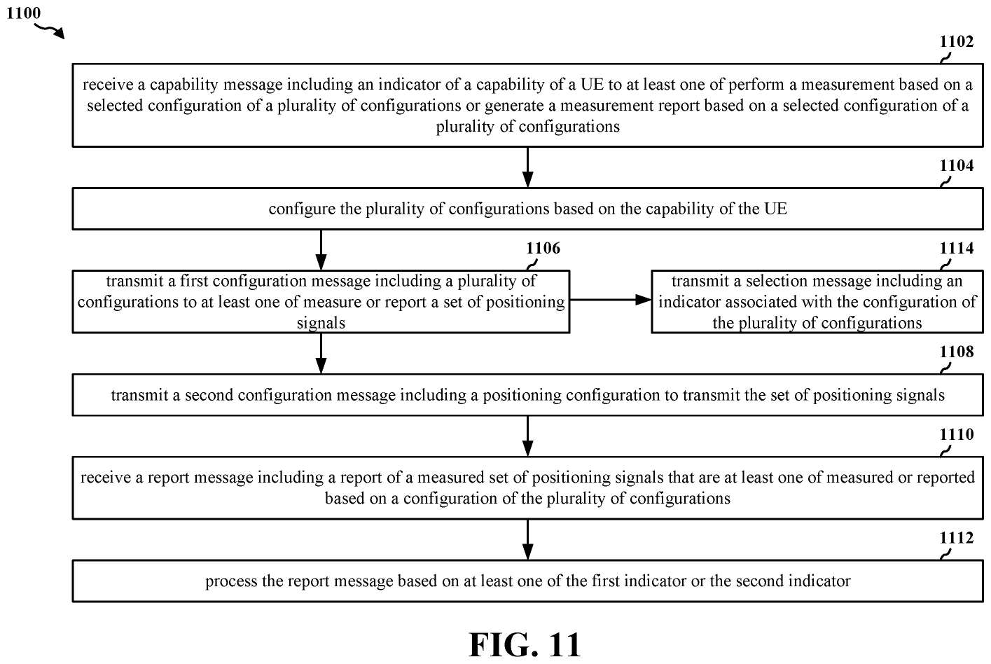

FIG. 11 is a flowchart 1100 of a method of wireless communication. The method may be performed by a network node (e.g., the base station 102, the base station 310; the wireless device 402, the wireless device 406, the wireless device 502, the wireless device 506; one of the set of positioning neighbor wireless devices 604, one of the set of positioning neighbor wireless devices 704; the positioning network entity 606, the positioning network entity 706; the network entity 1202, the network entity 1302, the network entity 1460).

At 1102, the network node may receive a capability message including an indicator of a capability of a UE to at least one of perform a measurement based on a selected configuration of a plurality of configurations or generate a measurement report based on a selected configuration of a plurality of configurations. For example, 1102 may be performed by the positioning network entity 606 in FIG. 6, which may receive the capability 612 from the positioning target wireless device 602. The positioning target wireless device 602 may transmit a capability message, such as an LPP message, including an indicator of the capability 612. The capability 612 may indicate the capability of the positioning target wireless device 602 to perform a measurement based on a selected configuration of a plurality of configurations and/or generate a measurement report based on a selected configuration of a plurality of configurations. Moreover, 1102 may be performed by the component 199 in FIG. 1, 3, 13, or 14.

At 1104, the network node may configure the plurality of configurations based on the capability of the UE. For example, 1104 may be performed by the positioning network entity 606 in FIG. 6, which may configure the plurality of configurations based on the capability of the UE. Moreover, 1104 may be performed by the component 199 in FIG. 1, 3, 13, or 14.

At 1106, the network node may transmit a first configuration message including a plurality of configurations to at least one of measure or report a set of positioning signals. For example, 1106 may be performed by the positioning network entity 606 in FIG. 6, which may transmit the configurations 616 to the positioning target wireless device 602. The configurations 616 may include a plurality of configurations to at least one of measure or report the set of positioning signals 624. Moreover, 1106 may be performed by the component 199 in FIG. 1, 3, 13, or 14.

At 1108, the network node may transmit a second configuration message including a positioning configuration to transmit the set of positioning signals. For example, 1108 may be performed by the positioning network entity 606 in FIG. 6, which may transmit the set of configurations 618 including a positioning configuration to transmit the set of positioning signals 624. Moreover, 1108 may be performed by the component 199 in FIG. 1, 3, 13, or 14.

At 1110, the network node may receive a report message including a report of a measured set of positioning signals that are at least one of measured or reported based on a configuration of the plurality of configurations. The report may include at least one of a first indicator of the configuration or a second indicator of the environmental condition associated with the configuration. The selected configuration may include at least one of a first indicator of a subsampling measurement criterion, a second indicator of a set of subsampling resource criterion, a third indicator of a set of measurement formats, a fourth indicator of a set of measurement attributes, or a fifth indicator of a set of measurement resolutions. The subsampling measurement criterion may include at least one of a maximum number of sample measurements, a maximum number of paths, a ranking of sample measurements associated with a metric, a threshold value associated with the metric, a sample window size, or a sixth indicator of a measurement type. The measurement type may include at least one of a CFR, a CIR, a PDP, a DP, or a multipath measurement type. The set of subsampling resource criterion may include at least one of a first range of a first number of TRPs associated with the set of positioning signals, a second range of a second number of positioning signal resources associated with the set of positioning signals, a set of TRP IDs associated with the set of positioning signals, a set of positioning signal resource IDs associated with the set of positioning signals, a first selection of a set of TRPs associated with the set of positioning signals, or a second selection of a set of positioning signal resources associated with the set of positioning signals. The set of measurement formats may include at least one of a first bitmap of a measurement attribute, a first encoding of the measurement attribute, a differential encoding of the measurement attribute, or a second bitmap of a second encoding of the measurement attribute. The set of measurement attributes may include at least one of timing information, frequency information, magnitude information, or angle information. The set of measurement resolutions may include at least one of a first oversampling factor associated with an FFT, or a second oversampling factor associated with an IFFT. For example, 1110 may be performed by the positioning network entity 606 in FIG. 6, which may receive the set of reports 628 from the positioning target wireless device 602. The set of reports 628 may include a report of a measured set of positioning signals that are at least one of measured or reported based on a configuration of the plurality of configurations transmitted as the configurations 616. The set of reports 628 may include an indicator of the configuration that the positioning target wireless device 602 selected at 619 and/or an indicator of the environmental condition that the positioning target wireless device 602 used to select the configuration at 619. The configuration selected by the positioning target wireless device 602 at 619 may include (a), an indicator of a subsampling measurement criterion, (b) an indicator of a set of subsampling resource criterion, (c) an indicator of a set of measurement formats, (d) an indicator of a set of measurement attributes, and/or (c) an indicator of a set of measurement resolutions. The subsampling measurement criterion may include (a) a maximum number of sample measurements, (b) a maximum number of paths, (c) a ranking of sample measurements associated with a metric (e.g., bounded by the metric, selected using the metric), (d) a threshold value associated with the metric (e.g., bounded by the metric), (c) a sample window size, and/or (f) an indicator of a measurement type. The measurement type may include a CFR, a CIR, a PDP, a DP, and/or a multipath measurement type. The set of subsampling resource criterion may include (a) a range of a number of TRPs that transmitted the set of positioning signals 624, (b) a range of a number of positioning signal resources that the set of positioning signals 624 use, (c) a set of TRP IDs that identify the TRPs that transmit the set of positioning signals 624, (d) a set of positioning signal resource IDs that identify the positioning signal resources that the set of positioning signals 624 use. (e) a selection of a set of TRPs that transmit positioning signals that the positioning target wireless device 602 should measure, and/or (f) a selection of a set of positioning signal resources that the positioning target wireless device 602 should measure when measuring the set of positioning signals 624. The set of measurement formats may include (a) a bitmap of a measurement attribute. (b) an encoding of the measurement attribute, (c) a differential encoding of the measurement attribute, and/or (d) a bitmap of an encoding of the measurement attribute. The set of measurement attributes may include (a) timing information, (b) frequency information, (c) magnitude information, and/or (d) angle information for measuring the set of positioning signals 624. The set of measurement resolutions may include an oversampling factor associated with an FFT and/or an oversampling factor associated with an IFFT. Moreover, 1110 may be performed by the component 199 in FIG. 1, 3, 13, or 14.

At 1112, the network node may process the report message based on at least one of the first indicator or the second indicator. For example, 1112 may be performed by the positioning network entity 606 in FIG. 6, which may, at 630, process the set of reports 628 received from the positioning target wireless device 602. The positioning target wireless device 602 may transmit a report message, for example an LPP message, that includes the set of reports 628. The set of reports 628 may include an indicator of the configuration selected by the positioning target wireless device 602 at 619. The set of reports 628 may include an indicator of the environmental condition used by the positioning target wireless device 602 to select the configuration selected at 619. The positioning network entity 606 may determine how the set of reports 628 is configured (e.g., what the set of reports 628 contains and how to process it) based on one or more such indicators. Moreover, 1112 may be performed by the component 199 in FIG. 1, 3, 13, or 14.

At 1114, the network node may transmit a selection message including an indicator associated with the configuration of the plurality of configurations. For example, 1114 may be performed by the positioning network entity 706 in FIG. 7, which may transmit the configuration selection 716 to the positioning target wireless device 702. The positioning network entity 706 may transmit a selection message, for example an LPP message, that includes an indicator associated with a selection of a subset of configurations from the configurations 708, narrowing down the choices of what configuration the positioning target wireless device 702 selects at 719. Moreover, 1114 may be performed by the component 199 in FIG. 1, 3, 13, or 14. The network node may include a base station, a TRP, or an LMF.

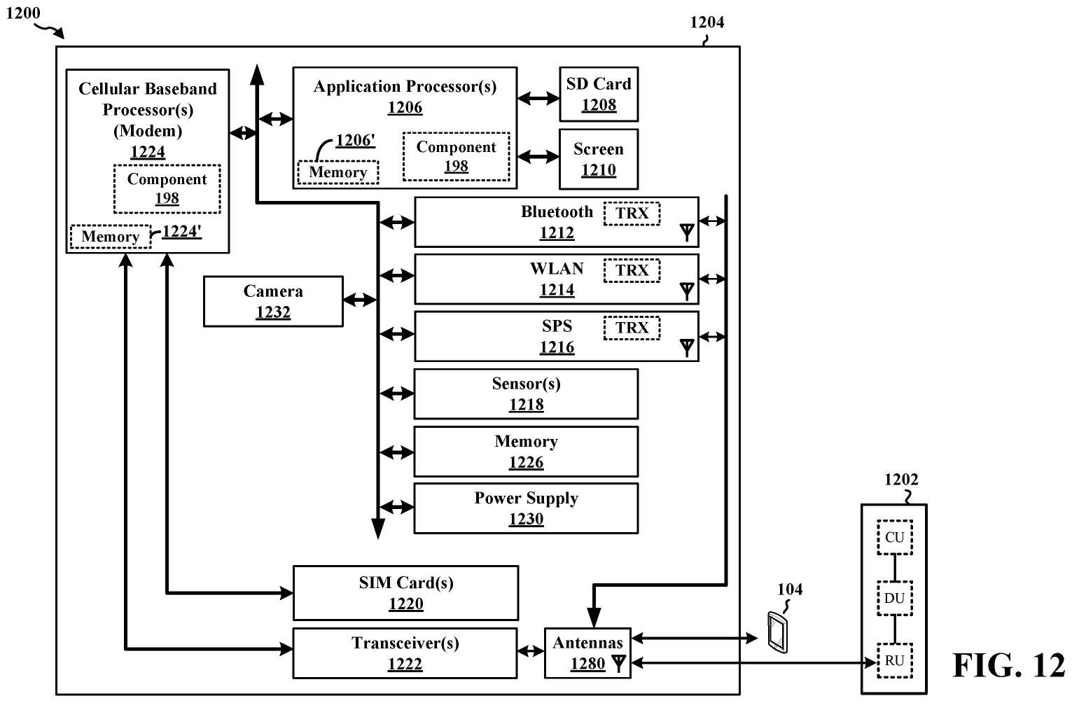

FIG. 12 is a diagram 1200 illustrating an example of a hardware implementation for an apparatus 1204. The apparatus 1204 may be a UE, a component of a UE, or may implement UE functionality. In some aspects, the apparatus 1004 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive a configuration message including a plurality of configurations to at least one of measure or report a set of positioning signals. The component 198 may be configured to select a configuration from the plurality of configurations. The component 198 may be configured to receive the set of positioning signals. The component 198 may be configured to measure the set of positioning signals and transmit a first report message including a first report of the measured set of positioning signals based on the selected configuration. The component 198 may be configured to measure the set of positioning signals based on the selected configuration and transmit a second report message including a second report of the measured set of positioning signals. The component 198 may be configured to measure the set of positioning signals based on the selected configuration and transmit a third report message including a third report of the measured set of positioning signals based on the selected configuration. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving a configuration message including a plurality of configurations to at least one of measure or report a set of positioning signals. The apparatus 1204 may include means for selecting a configuration from the plurality of configurations. The apparatus 1204 may include means for receiving the set of positioning signals. The apparatus 1204 may include means for measuring the set of positioning signals and transmitting a first report message including a first report of the measured set of positioning signals based on the selected configuration. The apparatus 1204 may include means for measuring the set of positioning signals based on the selected configuration and transmitting a second report message including a second report of the measured set of positioning signals. The apparatus 1204 may include means for measuring the set of positioning signals based on the selected configuration and transmitting a third report message including a third report of the measured set of positioning signals based on the selected configuration. The apparatus 1204 may include means for selecting the configuration by selecting the configuration based on an environmental condition associated with the apparatus 1204. At least one of the first report or the second report may include at least one of a first indicator of the selected configuration or a second indicator of the environmental condition associated with the apparatus 1204. The apparatus 1204 may include means for receiving a selection message including an indicator associated with the plurality of configurations. The apparatus 1204 may include means for selecting the configuration by selecting the configuration from the plurality of configurations based on the indicator. The selected configuration may include at least one of a first indicator of a subsampling measurement criterion, a second indicator of a set of subsampling resource criterion, a third indicator of a set of measurement formats, a fourth indicator of a set of measurement attributes, or a fifth indicator of a set of measurement resolutions. The subsampling measurement criterion may include at least one of a maximum number of sample measurements, a maximum number of paths, a ranking of sample measurements associated with a metric, a threshold value associated with the metric, a sample window size, or a sixth indicator of a measurement type. The measurement type may include at least one of a CFR, a CIR, a PDP, a DP, or a multipath measurement type. The set of subsampling resource criterion may include at least one of a first range of a first number of TRPs associated with the set of positioning signals, a second range of a second number of positioning signal resources associated with the set of positioning signals, a set of TRP IDs associated with the set of positioning signals, a set of positioning signal resource IDs associated with the set of positioning signals, a first selection of a set of TRPs associated with the set of positioning signals, or a second selection of a set of positioning signal resources associated with the set of positioning signals. The set of measurement formats may include at least one of a first bitmap of a measurement attribute, a first encoding of the measurement attribute, a differential encoding of the measurement attribute, or a second bitmap of a second encoding of the measurement attribute. The set of measurement attributes may include at least one of timing information, frequency information, magnitude information, or angle information. The set of measurement resolutions may include at least one of a first oversampling factor associated with an FFT, or a second oversampling factor associated with an IFFT. The apparatus 1204 may include means for transmitting a capability message including an indicator of a capability of the UE to perform the measurement or to generate at least one of the first report or the second report. The plurality of configurations may be based on the capability. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

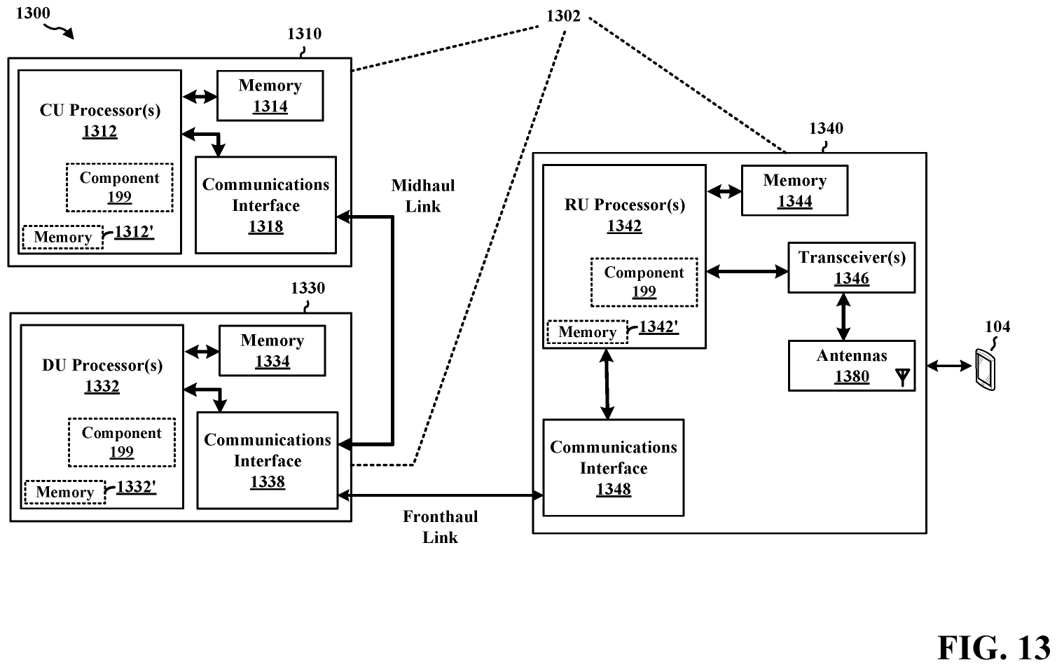

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a first configuration message including a plurality of configurations to at least one of measure or report a set of positioning signals. The component 199 may be configured to transmit a second configuration message including a positioning configuration to transmit the set of positioning signals. The component 199 may be configured to receive a report message including a report of a measured set of positioning signals that are at least one of measured or reported based on a configuration of the plurality of configurations. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting a first configuration message including a plurality of configurations to at least one of measure or report a set of positioning signals. The network entity 1302 may include means for transmitting a second configuration message including a positioning configuration to transmit the set of positioning signals. The network entity 1302 may include means for receiving a report message including a report of a measured set of positioning signals that are at least one of measured or reported based on a configuration of the plurality of configurations. The configuration may be associated with an environmental condition. The report may include at least one of a first indicator of the configuration or a second indicator of the environmental condition associated with the configuration. The network entity 1302 may include means for processing the report message based on at least one of the first indicator or the second indicator. The network entity 1302 may include means for transmitting a selection message including an indicator associated with the configuration of the plurality of configurations. The subsampling measurement criterion may include at least one of a maximum number of sample measurements, a maximum number of paths, a ranking of sample measurements associated with a metric, a threshold value associated with the metric, a sample window size, or a sixth indicator of a measurement type. The measurement type may include at least one of a CIR, a CFR, a PDP, a DP, or a multipath measurement type. The set of subsampling resource criterion may include at least one of a first range of a first number of TRPs associated with the set of positioning signals, a second range of a second number of positioning signal resources associated with the set of positioning signals, a set of TRP IDs associated with the set of positioning signals, a set of positioning signal resource IDs associated with the set of positioning signals, a first selection of a set of TRPs associated with the set of positioning signals, or a second selection of a set of positioning signal resources associated with the set of positioning signals. The set of measurement formats may include at least one of a first bitmap of a measurement attribute, a first encoding of the measurement attribute, a differential encoding of the measurement attribute, or a second bitmap of a second encoding of the measurement attribute. The set of measurement attributes may include at least one of timing information, frequency information, magnitude information, or angle information. The set of measurement resolutions may include at least one of a first oversampling factor associated with an FFT, or a second oversampling factor associated with an IFFT. The network entity 1302 may include means for receiving a capability message including an indicator of a capability of a UE to at least one of perform a measurement or generate a measurement report. The network entity 1302 may include means for configuring the plurality of configurations based on the capability of the UE. The network entity 1302 may include a base station, a TRP, or an LMF. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

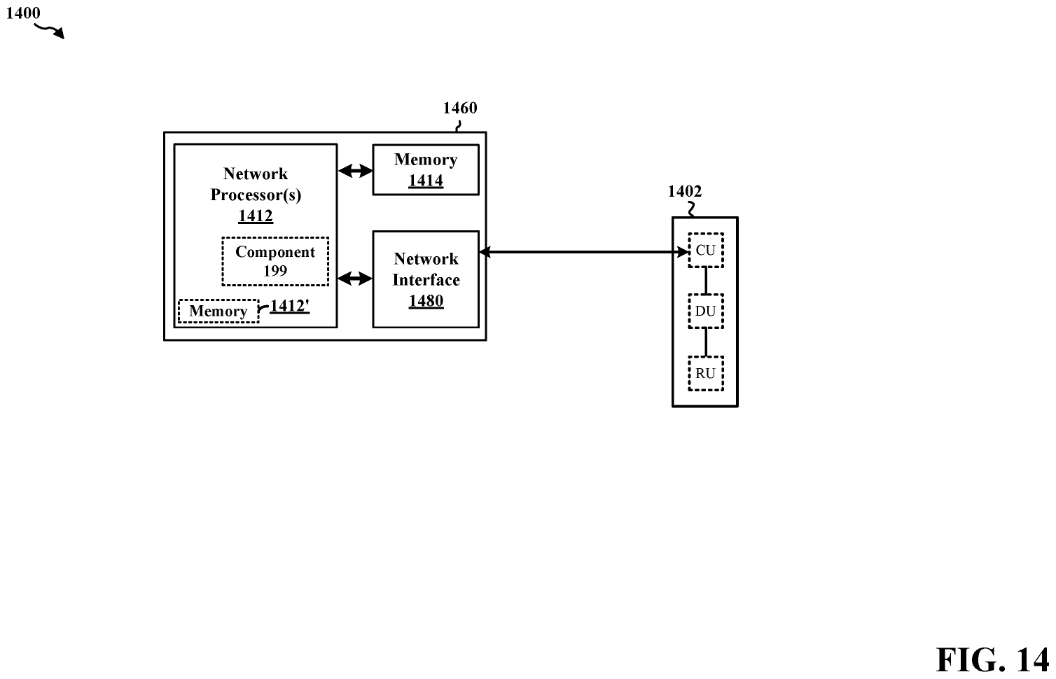

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′.

In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a first configuration message including a plurality of configurations to at least one of measure or report a set of positioning signals. The component 199 may be configured to transmit a second configuration message including a positioning configuration to transmit the set of positioning signals. The component 199 may be configured to receive a report message including a report of a measured set of positioning signals that are at least one of measured or reported based on a configuration of the plurality of configurations. The component 199 may be within the network processor(s) 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for transmitting a first configuration message including a plurality of configurations to at least one of measure or report a set of positioning signals. The network entity 1460 may include means for transmitting a second configuration message including a positioning configuration to transmit the set of positioning signals. The network entity 1460 may include means for receiving a report message including a report of a measured set of positioning signals that are at least one of measured or reported based on a configuration of the plurality of configurations. The configuration may be associated with an environmental condition. The report may include at least one of a first indicator of the configuration or a second indicator of the environmental condition associated with the configuration. The network entity 1460 may include means for processing the report message based on at least one of the first indicator or the second indicator. The network entity 1460 may include means for transmitting a selection message including an indicator associated with the configuration of the plurality of configurations. The subsampling measurement criterion may include at least one of a maximum number of sample measurements, a maximum number of paths, a ranking of sample measurements associated with a metric, a threshold value associated with the metric, a sample window size, or a sixth indicator of a measurement type. The measurement type may include at least one of a CIR, a CFR, a PDP, a DP, or a multipath measurement type. The set of subsampling resource criterion may include at least one of a first range of a first number of TRPs associated with the set of positioning signals, a second range of a second number of positioning signal resources associated with the set of positioning signals, a set of TRP IDs associated with the set of positioning signals, a set of positioning signal resource IDs associated with the set of positioning signals, a first selection of a set of TRPs associated with the set of positioning signals, or a second selection of a set of positioning signal resources associated with the set of positioning signals. The set of measurement formats may include at least one of a first bitmap of a measurement attribute, a first encoding of the measurement attribute, a differential encoding of the measurement attribute, or a second bitmap of a second encoding of the measurement attribute. The set of measurement attributes may include at least one of timing information, frequency information, magnitude information, or angle information. The set of measurement resolutions may include at least one of a first oversampling factor associated with an FFT, or a second oversampling factor associated with an IFFT. The network entity 1460 may include means for receiving a capability message including an indicator of a capability of a UE to at least one of perform a measurement or generate a measurement report. The network entity 1460 may include means for configuring the plurality of configurations based on the capability of the UE. The network entity 1460 may include a base station, a TRP, or an LMF. The means may be the component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. A range may refer to values greater than or equal to a threshold (e.g., x>y or x≥y), values less than or equal to a threshold (e.g., x<y or x≤y), or values bounded by two thresholds (e.g., a<x<y, a≤x≤y, a≤x≤y, or a≤x<y). Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may send the data to a component of the device. A device configured to “obtain” data, such as a transmission, signal, or message, may receive, for example with a transceiver, may obtain the data from a device that receives the data, or may obtain the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving a configuration message comprising a plurality of configurations to at least one of measure or report a set of positioning signals; selecting a configuration from the plurality of configurations; receiving the set of positioning signals; and at least one of (a) measuring the set of positioning signals and transmitting a first report message comprising a first report of the measured set of positioning signals based on the selected configuration or (b) measuring the set of positioning signals based on the selected configuration and transmitting a second report message comprising a second report of the measured set of positioning signals.

Aspect 2 is the method of aspect 1, wherein selecting the configuration comprises selecting the configuration based on an environmental condition associated with the UE, wherein at least one of the first report or the second report comprises at least one of a first indicator of the selected configuration or a second indicator of the environmental condition associated with the UE.

Aspect 3 is the method of either of aspects 1 or 2, further comprising receiving a selection message comprising an indicator associated with the plurality of configurations, wherein selecting the configuration comprises selecting the configuration from the plurality of configurations based on the indicator.

Aspect 4 is the method of any of aspects 1 to 3, wherein the selected configuration comprises at least one of: a first indicator of a subsampling measurement criterion; a second indicator of a set of subsampling resource criterion; a third indicator of a set of measurement formats; a fourth indicator of a set of measurement attributes; or a fifth indicator of a set of measurement resolutions.

Aspect 5 is the method of aspect 4, wherein the subsampling measurement criterion comprise at least one of: a maximum number of sample measurements; a maximum number of paths; a ranking of sample measurements associated with a metric; a threshold value associated with the metric; a sample window size; or a sixth indicator of a measurement type.

Aspect 6 is the method of aspect 5, wherein the measurement type comprises at least one of a channel frequency response (CFR), a channel impulse response (CIR), a power delay profile (PDP), a delay profile (DP), or a multipath measurement type (e.g., multi-RTT, RSRPP, TDoA).

Aspect 7 is the method of any of aspects 4 to 6, wherein the set of subsampling resource criterion comprise at least one of: a first range of a first number of transmission reception points (TRPs) associated with the set of positioning signals; a second range of a second number of positioning signal resources associated with the set of positioning signals; a set of TRP IDs associated with the set of positioning signals; a set of positioning signal resource IDs associated with the set of positioning signals; a first selection of a set of TRPs associated with the set of positioning signals; or a second selection of a set of positioning signal resources associated with the set of positioning signals.

Aspect 8 is the method of any of aspects 4 to 7, wherein the set of measurement formats comprises at least one of: a first bitmap of a measurement attribute; a first encoding of the measurement attribute; a differential encoding of the measurement attribute; or a second bitmap of a second encoding of the measurement attribute.

Aspect 9 is the method of any of aspects 4 to 8, wherein the set of measurement attributes comprise at least one of: timing information; frequency information; magnitude information; or angle information.

Aspect 10 is the method of any of aspects 4 to 9, wherein the set of measurement resolutions comprise at least one of: a first oversampling factor associated with a fast Fourier transform (FFT); or a second oversampling factor associated with an inverse fast Fourier transform (IFFT).

Aspect 11 is the method of any of aspects 1 to 10, further comprising transmitting a capability message comprising an indicator of a capability of the UE to perform the measurement or to generate at least one of the first report or the second report, wherein the plurality of configurations is based on the capability.

Aspect 12 is a method of wireless communication at a network node, comprising: transmitting a first configuration message comprising a plurality of configurations to at least one of measure or report a set of positioning signals; transmitting a second configuration message comprising a positioning configuration to transmit the set of positioning signals; and receiving a report message comprising a report of a measured set of positioning signals that are at least one of measured or reported based on a configuration of the plurality of configurations.

Aspect 13 is the method of aspect 12, wherein the configuration is associated with an environmental condition, wherein the report comprises at least one of a first indicator of the configuration or a second indicator of the environmental condition associated with the configuration.

Aspect 14 is the method of aspect 13, further comprising processing the report message based on at least one of the first indicator or the second indicator.

Aspect 15 is the method of any of aspects 12 to 14, further comprising transmitting a selection message comprising an indicator associated with the configuration of the plurality of configurations.

Aspect 16 is the method of any of aspects 12 to 14, wherein the configuration comprises at least one of: a first indicator of a subsampling measurement criterion; a second indicator of a set of subsampling resource criterion; a third indicator of a set of measurement formats; a fourth indicator of a set of measurement attributes; or a fifth indicator of a set of measurement resolutions.

Aspect 17 is the method of aspect 16, wherein the subsampling measurement criterion comprise at least one of: a maximum number of sample measurements; a maximum number of paths; a ranking of sample measurements associated with a metric; a threshold value associated with the metric; a sample window size; or a sixth indicator of a measurement type.

Aspect 18 is the method of aspect 17, wherein the measurement type comprises at least one of a channel frequency response (CFR), a channel impulse response (CIR), a power delay profile (PDP), a delay profile (DP), or a multipath measurement type.

Aspect 19 is the method of any of aspects 16 to 18, wherein the set of subsampling resource criterion comprise at least one of: a first range of a first number of transmission reception points (TRPs) associated with the set of positioning signals; a second range of a second number of positioning signal resources associated with the set of positioning signals; a set of TRP IDs associated with the set of positioning signals; a set of positioning signal resource IDs associated with the set of positioning signals; a first selection of a set of TRPs associated with the set of positioning signals; or a second selection of a set of positioning signal resources associated with the set of positioning signals.

Aspect 20 is the method of any of aspects 16 to 19, wherein the set of measurement formats comprises at least one of: a first bitmap of a measurement attribute; a first encoding of the measurement attribute; a differential encoding of the measurement attribute; or a second bitmap of a second encoding of the measurement attribute.

Aspect 21 is the method of any of aspects 16 to 20, wherein the set of measurement attributes comprise at least one of: timing information; frequency information; magnitude information; or angle information.

Aspect 22 is the method of any of aspects 16 to 21, wherein the set of measurement resolutions comprise at least one of: a first oversampling factor associated with a fast Fourier transform (FFT); or a second oversampling factor associated with an inverse fast Fourier transform (IFFT).

Aspect 23 is the method of any of aspects 12 to 22, further comprising: receiving a capability message comprising an indicator of a capability of a user equipment (UE) to at least one of perform a measurement or generate a measurement report; and configuring the plurality of configurations based on the capability of the UE.

Aspect 24 is the method of any of aspects 12 to 23, wherein the network node comprises a base station, a transmission reception point (TRP), or a location management function (LMF).

Aspect 25 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 24.

Aspect 26 is an apparatus for wireless communication, comprising means for performing each step in the method of any of aspects 1 to 24.

Aspect 27 is the apparatus of any of aspects 1 to 24, further comprising a transceiver configured to receive or to transmit in association with the method of any of aspects 1 to 24.

Aspect 28 is a computer-readable medium (e.g., a non-transitory computer-readable medium) storing computer executable code, the code when executed by at least one processor causes the at least one processor to perform the method of any of aspects 1 to 24.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive a configuration message comprising a plurality of configurations to at least one of measure or report a set of positioning signals;
select a configuration from the plurality of configurations;
receive the set of positioning signals; and
at least one of (a) measure the set of positioning signals and transmit a first report message comprising a first report of the measured set of positioning signals based on the selected configuration or (b) measure the set of positioning signals based on the selected configuration and transmit a second report message comprising a second report of the measured set of positioning signals.

2. The apparatus of claim 1, wherein, to select the configuration, the at least one processor, individually or in any combination, is configured to:
select the configuration based on an environmental condition associated with the UE, wherein at least one of the first report or the second report comprises at least one of a first indicator of the selected configuration or a second indicator of the environmental condition associated with the UE.

3. The apparatus of claim 1, wherein the at least one processor, individually or in any combination, is further configured to:
receive a selection message comprising an indicator associated with the plurality of configurations, wherein, to select the configuration, the at least one processor, individually or in any combination, is configured to select the configuration from the plurality of configurations based on the indicator.

4. The apparatus of claim 1, wherein the selected configuration comprises at least one of:
a first indicator of a subsampling measurement criterion;
a second indicator of a set of subsampling resource criterion;
a third indicator of a set of measurement formats;
a fourth indicator of a set of measurement attributes; or
a fifth indicator of a set of measurement resolutions.

5. The apparatus of claim 4, wherein the subsampling measurement criterion comprise at least one of:
a maximum number of sample measurements;
a maximum number of paths;
a ranking of sample measurements associated with a metric;
a threshold value associated with the metric;
a sample window size; or
a sixth indicator of a measurement type.

6. The apparatus of claim 5, wherein the measurement type comprises at least one of a channel frequency response (CFR), a channel impulse response (CIR), a power delay profile (PDP), a delay profile (DP), or a multipath measurement type.

7. The apparatus of claim 4, wherein the set of subsampling resource criterion comprise at least one of:
a first range of a first number of transmission reception points (TRPs) associated with the set of positioning signals;
a second range of a second number of positioning signal resources associated with the set of positioning signals;
a set of TRP IDs associated with the set of positioning signals;
a set of positioning signal resource IDs associated with the set of positioning signals;
a first selection of a set of TRPs associated with the set of positioning signals; or
a second selection of a set of positioning signal resources associated with the set of positioning signals.

8. The apparatus of claim 4, wherein the set of measurement formats comprises at least one of:
a first bitmap of a measurement attribute;
a first encoding of the measurement attribute;
a differential encoding of the measurement attribute; or
a second bitmap of a second encoding of the measurement attribute.

9. The apparatus of claim 4, wherein the set of measurement attributes comprise at least one of:
timing information;
frequency information;
magnitude information; or
angle information.

10. The apparatus of claim 4, wherein the set of measurement resolutions comprise at least one of:
a first oversampling factor associated with a fast Fourier transform (FFT); or
a second oversampling factor associated with an inverse fast Fourier transform (IFFT).

11. The apparatus of claim 1, further comprising a transceiver coupled to the at least one processor, wherein the at least one processor, individually or in any combination, is further configured to:
transmit, via the transceiver, a capability message comprising an indicator of a capability of the UE to perform the measurement or to generate at least one of the first report or the second report, wherein the plurality of configurations is based on the capability.

12. An apparatus for wireless communication at a network node, comprising:
at least one memory; and
at least one processor coupled to the at least one memory and, based at least in part on information stored in the at least one memory, the at least one processor, individually or in any combination, is configured to:
transmit a first configuration message comprising a plurality of configurations to at least one of measure or report a set of positioning signals;
transmit a second configuration message comprising a positioning configuration to transmit the set of positioning signals; and
receive a report message comprising a report of a measured set of positioning signals that are at least one of measured or reported based on a configuration of the plurality of configurations.

13. The apparatus of claim 12, wherein the configuration is associated with an environmental condition, wherein the report comprises at least one of a first indicator of the configuration or a second indicator of the environmental condition associated with the configuration.

14. The apparatus of claim 13, wherein the at least one processor, individually or in any combination, is further configured to:
process the report message based on at least one of the first indicator or the second indicator.

15. The apparatus of claim 12, wherein the at least one processor, individually or in any combination, is further configured to:
transmit a selection message comprising an indicator associated with the configuration of the plurality of configurations.

16. The apparatus of claim 12, wherein the configuration comprises at least one of:
a first indicator of a subsampling measurement criterion;
a second indicator of a set of subsampling resource criterion;
a third indicator of a set of measurement formats;
a fourth indicator of a set of measurement attributes; or
a fifth indicator of a set of measurement resolutions.

17. The apparatus of claim 16, wherein the subsampling measurement criterion comprise at least one of:
a maximum number of sample measurements;
a maximum number of paths;
a ranking of sample measurements associated with a metric;
a threshold value associated with the metric;
a sample window size; or
a sixth indicator of a measurement type.

18. The apparatus of claim 17, wherein the measurement type comprises at least one of a channel frequency response (CFR), a channel impulse response (CIR), a power delay profile (PDP), a delay profile (DP), or a multipath measurement type.

19. The apparatus of claim 16, wherein the set of subsampling resource criterion comprise at least one of:
a first range of a first number of transmission reception points (TRPs) associated with the set of positioning signals;
a second range of a second number of positioning signal resources associated with the set of positioning signals;
a set of TRP IDs associated with the set of positioning signals;
a set of positioning signal resource IDs associated with the set of positioning signals;
a first selection of a set of TRPs associated with the set of positioning signals; or
a second selection of a set of positioning signal resources associated with the set of positioning signals.

20. The apparatus of claim 16, wherein the set of measurement formats comprises at least one of:
a first bitmap of a measurement attribute;
a first encoding of the measurement attribute;
a differential encoding of the measurement attribute; or
a second bitmap of a second encoding of the measurement attribute.

21. The apparatus of claim 16, wherein the set of measurement attributes comprise at least one of:
timing information;
frequency information;
magnitude information; or
angle information.

22. The apparatus of claim 16, wherein the set of measurement resolutions comprise at least one of:
a first oversampling factor associated with a fast Fourier transform (FFT); or
a second oversampling factor associated with an inverse fast Fourier transform (IFFT).

23. The apparatus of claim 12, further comprising a transceiver coupled to the at least one processor, wherein the at least one processor, individually or in any combination, is further configured to:
receive, via the transceiver, a capability message comprising an indicator of a capability of a user equipment (UE) to at least one of perform a measurement or generate a measurement report; and
configure the plurality of configurations based on the capability of the UE.

24. The apparatus of claim 12, wherein the network node comprises a base station, a transmission reception point (TRP), or a location management function (LMF).

25. A method of wireless communication at a user equipment (UE), comprising:
receiving a configuration message comprising a plurality of configurations to at least one of measure or report a set of positioning signals;
selecting a configuration from the plurality of configurations;
receiving the set of positioning signals; and
at least one of (a) measuring the set of positioning signals and transmitting a first report message comprising a first report of the measured set of positioning signals based on the selected configuration or (b) measuring the set of positioning signals based on the selected configuration and transmitting a second report message comprising a second report of the measured set of positioning signals.

26. The method of claim 25, wherein selecting the configuration comprises selecting the configuration based on an environmental condition associated with the UE, wherein at least one of the first report or the second report comprises at least one of a first indicator of the selected configuration or a second indicator of the environmental condition associated with the UE.

27. The method of claim 25, further comprising:
receiving a selection message comprising an indicator associated with the plurality of configurations, wherein selecting the configuration comprises selecting the configuration from the plurality of configurations based on the indicator.

28. The method of claim 25, further comprising:
transmitting a capability message comprising an indicator of a capability of the UE to perform the measurement or to generate at least one of the first report or the second report, wherein the plurality of configurations is based on the capability.

29. A method of wireless communication at a network node, comprising:
transmitting a first configuration message comprising a plurality of configurations to at least one of measure or report a set of positioning signals;
transmitting a second configuration message comprising a positioning configuration to transmit the set of positioning signals; and
receiving a report message comprising a report of a measured set of positioning signals that are at least one of measured or reported based on a configuration of the plurality of configurations.

30. The method of claim 29, further comprising:
receiving a capability message comprising an indicator of a capability of a user equipment (UE) to at least one of perform a measurement or generate a measurement report; and
configuring the plurality of configurations based on the capability of the UE.
